(19) United States
(12) Patent Application Publication
(10) Pub. No.: US 2022/0351284 A1
(43) Pub. Date: Nov. 3, 2022

(54) SYSTEM AND METHOD FOR THE RAPID, FLEXIBLE APPROVAL AND DISBURSEMENT OF A LOAN

(71) Applicant: BANCO DAVIVIENDA S.A., Bogotá (CO)

(72) Inventors: Jorge Eduardo CAÑÓN PAEZ, Bogotá (CO); Martha Isabel FUQUEN PRECIADO, Bogotá (CO); Diego GUECHA LOPEZ, Bogotá (CO); Margarita Maria HENAO CABRERA, Bogotá (CO); Martín Alejandro LOVO HERNANDEZ, Bogotá (CO); Mauricio NAVARRETE CAICEDO, Bogotá (CO); Paula REYES DEL TORO, Bogotá (CO)

(21) Appl. No.: 17/622,194

(22) PCT Filed: Jun. 18, 2020
(86) PCT No.: PCT/IB2020/055754

§ 371 Date: Dec. 22, 2021

(30) Foreign Application Priority Data
Jun. 24, 2019 (CO) NC2019/0006711

(51) Int. Cl. G06Q 40/02

(52) U.S. Cl. CPC G06Q 40/025; G06Q 50/01

(57) ABSTRACT

This invention relates to a system and method for approving, depositing and disbursing a credit in a fast and agile manner. The method in this invention comprises a stage i) of receiving at a first server a request data generated on a computing device connected to the first server when a user enters a selection command associated with a type of credit.

Moreover, the method may include a stage ii) of obtaining at the computing device a user identification data provided by the user and a sub-stage ii-a) of transmitting the user identification data to the first server. Furthermore, the method may further comprise a stage iii) of obtaining via a second server a scoring data packet comprising a user history and profiling data, wherein the second server is configured to extract the user history and profiling data from one or more databases.

Additionally, the method may include a stage iv) of obtaining via a risk server an approval data, a counteroffer data, or a denial data via a scoring process that takes as input the scoring data packet and one or more compliance rules related to the credit, wherein the scoring process is selected from classification processes and rule-based artificial intelligence processes. Also, the method may include a stage v) of executing via the first server a credit creation and disbursement process if the approval data or the counteroffer data is obtained.

On the other hand, this invention relates to a credit approval and disbursement system configured to perform stages of any embodiment of the methods of the invention described in this disclosure. Also, this invention relates to a computer program and a computer-readable medium with instructions, which when the program is executed in a system in accordance with any embodiment described in this disclosure cause said system to carry out stages of a method in accordance with any embodiment of the methods described in this disclosure.

### RELATED TECHNICAL FIELD

This invention relates to systems and methods of credit scoring and data transfer authorization. In addition, this invention relates to systems and methods of authentication, comparison and risk score generation.

### BACKGROUND OF THE INVENTION

U.S. Pat. No. 8,515,862 entitled “Computer-implemented systems and methods for integrated model validation for compliance and credit risk”, discloses computer-implemented systems and methods for validation of a compliance and credit risk model. Input, output, and validation processing areas are included in a computer system. An identifier data structure connects the validation areas of the model with identifiers comprising a unified metric. An identifier represents combinations of covariate patterns and describes the joint distribution of risk characteristics.

U.S. Pat. No. 6,405,181 entitled “Method and apparatus for real-time online credit approval”, teaches a system and method for providing real-time credit approval over a network. The method includes obtaining data from an applicant. The applicant's data is analyzed in a form suitable for directly obtaining a credit report from a credit bureau. The applicant's credit report is obtained with credit report data from a credit bureau. A determination is then made as to whether the applicant should be accepted using the credit report data and the applicant is notified that the application has been approved.

Patent application CN 109670936, entitled “Loan examination & approval processing method, platform, equipment and computer readable storage medium”, describes a processing method for examining the type of loans, which is applied to the loan platform.

This method comprises: extracting applicant information and credit information from loan applications when loan applications are received from the transmission terminal; the applicant's credit scoring is obtained according to the applicant's information; according to the loan product and the loan amount of the credit information, predetermined verification conditions are searched for matching in the database with the credit information; according to the predetermined scoring conditions and the credit scoring, the loa scoring grade for the applicant is determined, and; the loan is examined according to the determining loa scoring grade. The invention also discloses a type of computer-readable platform, equipment and storage media. This invention reduces the cycles of the loan process, while reducing the possibility of occurrence of a risk event, and at the same time, promotes the development of loan transactions and achieves the beneficial effect of risk management and control.

Patent application WO 2019/074446 entitled “System and method for processing a loan application”, teaches a system and method for processing a loan application. The system includes a processor; and a memory unit communicatively coupled to the processor, wherein the memory unit is configured to receive a loan application from an applicant and applicant-specific scoring data to provide a scoring of the loan application; and wherein the processor is configured to: analyze the scoring data to determine a plurality of assessment scores specific to the applicant; and determine an outcome of the loan application based on the assessment scores, and wherein the assessment scores comprise a risk score determined based on the credit risk and behavioral risk of the applicant.

Patent application WO 2019/061989 entitled “Loan risk control method, electronic device and readable storage medium”, discloses a loan risk control method, an electronic device and a readable storage medium. The method comprises: associating predefined seed users having different loan risk levels with a preset user profile to obtain user profile data having different loan risk levels; performing training based on the user profile data having different loan risk levels to obtain a hierarchical model for loan risk levels; and using the hierarchical model to classify users in a preset application program into different loan risk levels; according to the different loan risk levels corresponding to the users in the predetermined application program, calculating the risk scores of the users in the predetermined application program according to the predetermined scoring rules, displaying a predetermined lending input to the users whose scores satisfy the predetermined requirements. This application reduces the risk of loan companies and increases the conversion rate of loan users.

Patent application WO 2012/097171 entitled “Systems and methods for using online social footprint for affecting lending performance and credit scoring”, teaches apparatus, IT resources and methods for analyzing data collected from online social footprint and determining a credit score to facilitate access to financial services. A credit model is constructed to determine a credit score that is based on available personal data and data collected from the online social footprint and is indicative of the borrower's propensity to repay an amount owed. A credit score is determined from a scoring expression that is associated with a group of scores and typically includes a subset of available data collected from the online social footprint. An individual's credit score may also be affected by means such as endorsements or negative behavior of individuals in a borrower's social network. Corresponding apparatuses, systems, computer programs, and communication mechanisms are also provided for gaining access to financial services based on at least one of a borrower's application criteria, optimization of reputation in the borrower's online social footprint, and completion of a loan transaction.

However, the prior art does not provide a system and method for the approval and disbursement of a loan in a quick and agile manner.

### BRIEF DESCRIPTION OF THE INVENTION

This invention relates to a method of approving and disbursing a credit comprising a stage i) of receiving at a first server a request data generated on a computing device connected to the first server, when a user enters a selection command associated with a type of credit.

Moreover, the method may comprise a stage ii) of obtaining at the computing device a user identification data provided by the user at said computing device and a sub-stage ii-a) of transmitting the user identification data to the first server.

Furthermore, the method may comprise a stage iii) of obtaining via a second server connected to the first server a scoring data packet comprising a user history and profiling data, wherein the second server is configured to extract from one or more databases the user history and profiling data from the user data of the previous stage.

Additionally, the method may include a stage iv) of obtaining an approval data via a risk server connected to the first server, a counteroffer data, or a denial data via a scoring process that takes as input the scoring data packet and one or more credit-related compliance rules, wherein the scoring process is selected between classification processes and rule-based artificial intelligence processes.

Also, the method may include a stage (v) of executing a credit creation and disbursement process through the first server, if the approval data or the counteroffer data is obtained.

The process of creating and disbursing credit may include a sub-step V1) of obtaining a user acceptance data or counteroffer acceptance data from user interaction with the computing device and communication between the computing device and the first server. Moreover, the process of creating and disbursing credit has a V2) stage of creating credit and transferring a data representing money to a user account.

On the other hand, this invention relates to a credit approval and disbursement system configured to perform stages of any embodiment of the methods of the invention described in this disclosure. The system may include a first server that establishes connection with a computing device, a second server connected to the first server, a risk server connected to the first server, wherein the first server is connected to the second server, the risk server and the computing device via a computer network.

On the other hand, this invention also relates to a computer program comprising instructions, which when the program is executed in a system according to any embodiment described in this disclosure, cause said system to carry out the stages of a method according to any embodiment of the methods described in this disclosure.

On the other hand, this invention also relates to a computer-readable medium comprising instructions, which when the program is executed in a system according to any of the aforementioned embodiments, cause said system to carry out the stages of a method according to any embodiment of the methods previously described in this disclosure.

### BRIEF DESCRIPTION OF THE FIGURES

FIG. 1. Shows an embodiment of the system and method for the approval and disbursement of a loan (2000), in a general way.

FIG. 2. Shows an embodiment of the system general flow and method for the approval and disbursement of a loan (2000).

FIG. 3. Shows an embodiment of the login process (200).

FIG. 4. Shows an embodiment of the pre-validation and filtering process (400).

FIG. 5. Shows an embodiment of the process of simulating credit (500).

FIG. 6. Shows an embodiment of the credit scoring process (700).

FIG. 7. Shows an embodiment of the process to submit an offer to the client (800).

FIG. 8. Shows an embodiment of the process for approvals and documents (900).

FIG. 9. Shows an embodiment of the process to generate and verify OTP (1000).

FIG. 10. Shows an embodiment of the process to generate electronic documents (1100).

FIG. 11. Shows an embodiment of the process to create credit and deposit data representing money in account (1200).

FIG. 12. Shows a process flow diagram of one embodiment of the method in this invention.

FIG. 13. Shows a block diagram of one embodiment of the system in this present invention.

FIG. 14. Shows a process flow diagram of one embodiment of a screening detection process in the method of this invention.

FIG. 15. Shows a block diagram for one embodiment of a screening detection process of the method in this invention.

FIG. 16. Shows a process flow diagram of one embodiment of the method illustrated in FIG. 1, detailing sub-stages of stage v) shown in FIG. 1,

FIG. 17. Shows a block diagram for the embodiment of the method illustrated in FIG. 16.

FIG. 18. Shows a block diagram for one embodiment of the system in this invention, having a plurality of interconnected servers in a web service architecture.

### DETAILED DESCRIPTION OF THE INVENTION

In several embodiments of the method in this invention, the method can be executed in 5 minutes or less.

In a first embodiment of the method in this invention, the user, also referred to as client in this disclosure, follows a series of steps, stages and sub-stages at the time of the credit application, which correspond to stages of the method that are executed by elements of the system in the invention, such as a first server (20), a computing device (10) to which the user has access, and other servers (30, 40, 22, 24) that may be connected to the first server (20). Next, the flows of each of the processes that the method disclosed herein may have, are detailed, except for processes (100), (600) and (1300) which do not constitute complex processes.

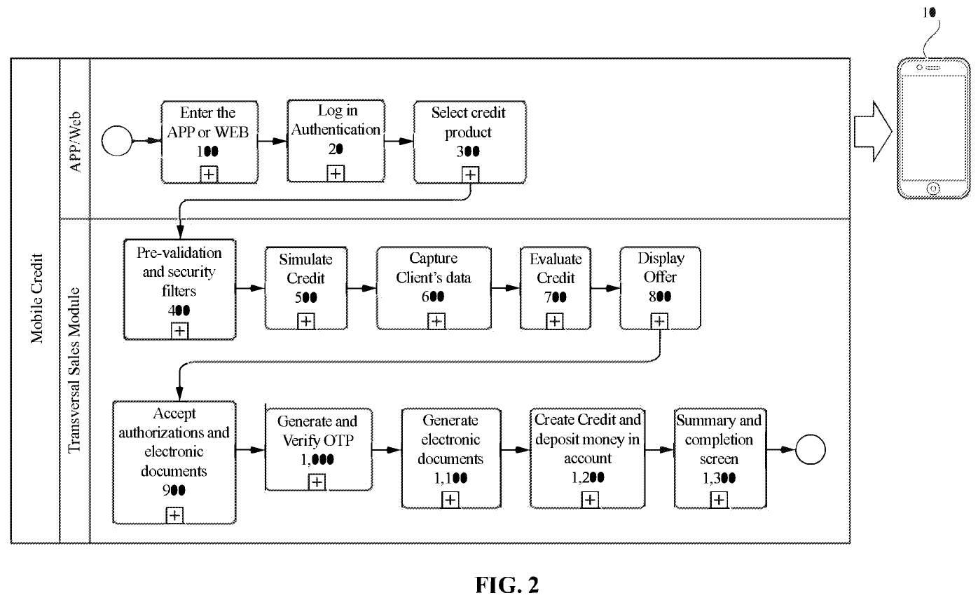

Referring to FIG. 2, the general flow of the system and method for approval and disbursement of a loan (2000) is shown. Steps (100) to (300) are performed by the user on a computing platform accessed by the computing device (10), also referred to as an electronic processing device (10) throughout this disclosure, which may be a cell phone, tablet, computer, or any item having a processing unit configured to receive instructions from the user via user interaction module (e.g. touch screen, buttons, keyboards, keypads, pointers, signalers, gesture detection elements, voice input devices, and combinations thereof), and having a user interface configured to display messages and information to the user (e.g., screens, printers, audio output devices, projectors, and combinations thereof), among other equivalent computing devices known to a person reasonably skilled in the art.

For example, the user may enter a transactional channel such as a web page, executable application, through which the user interacts with the computing device (10) at stages of the method where the user is required to enter, authorize, or modify data.

Steps (400) to (1300) are performed by the Transversal Sales Module (TSM).

A platform login step (100) is executed, in which the user enters the mobile application (APP) or the bank's website. Then a login process (200) is executed, in which the user logs in with his or her identification credentials and is authenticated by the credit approval and disbursement system (2000).

At the moment, the user selects the credit product (300), a process is activated in which the system (2000) performs the following steps such as running pre-validation and security filters (400), simulate credit (500), capture client's data (600), evaluate credit (700), submit offer (800), accept authorizations and electronic documents (900), generate and verify OTP (One Time Password) (1000), generate electronic documents (1100), create credit and deposit money in account (1200) and illustrate on screen summary and completion (1300).

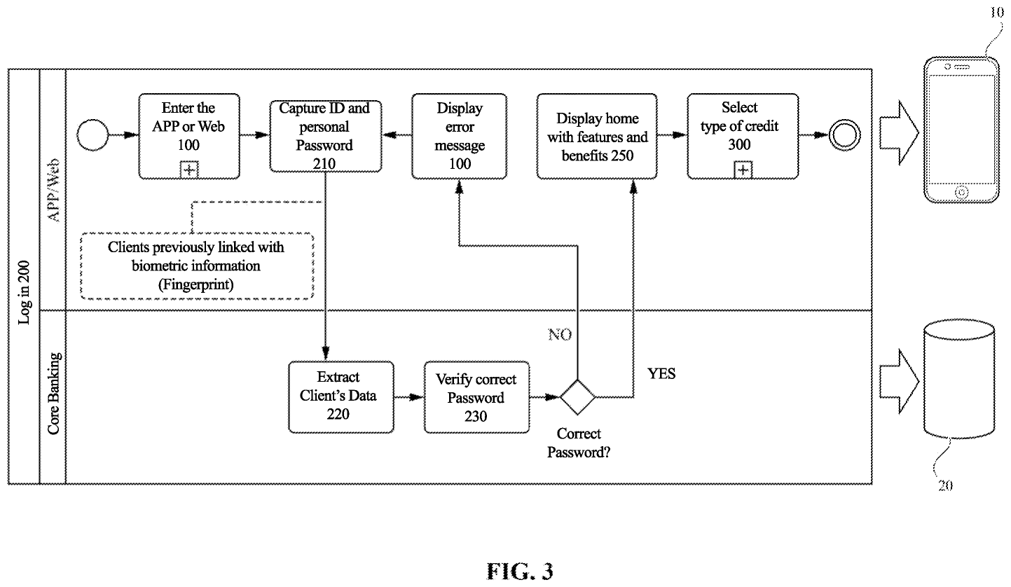

In FIG. 3, the login process (200) of the system and method (2000) is shown. Clients who are authenticated by a personal key were previously linked to the bank by biometric authentication.

If a user is not yet a client of the financial institution, he/she can be linked through the electronic processing device (10) that has the Bank's App by means of biometric authentication vs ID.

Having entered the financial institution's computer channel, the user proceeds to enter his/her personal identification and password (210). The core banking can call or bring data from an external database of a Bank server (20), in which it extracts the user data (220) and verifies the password (230). If the password is incorrect, an error message is displayed (240). After verifying the input data correctly, an interaction screen is displayed (250) in which the user is shown the characteristics and benefits of each type of credit and proceeds to the next process, which is to select the type of credit (300).

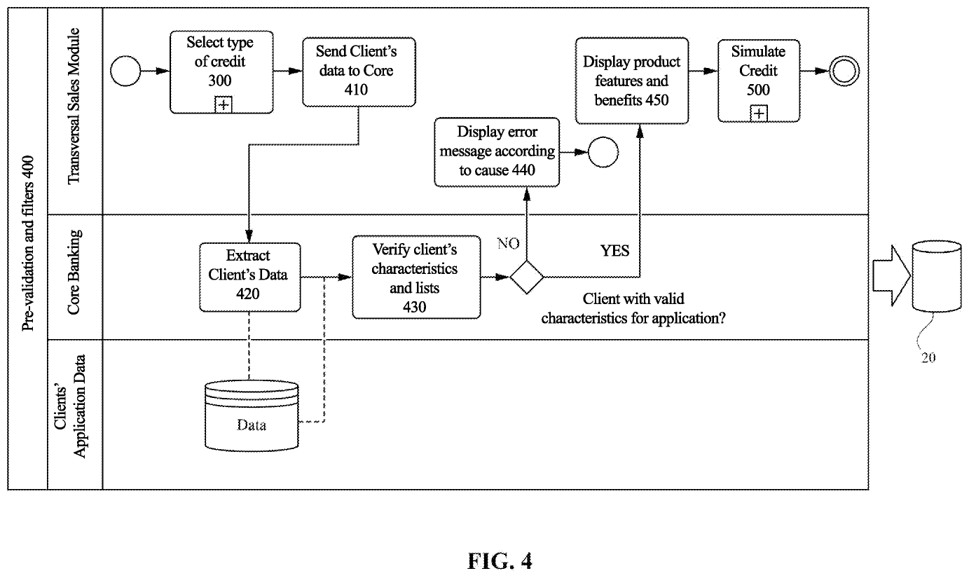

FIG. 4 illustrates the pre-validation and filtering process (400). This process (400) is transparent to the client and is executed as a security filter prior to start the credit application.

When the user has selected the type of credit (300), the Transversal Sales Module (TSM) sends the client's data to the core (410).

The core banking may call or fetch data from an external database of a Bank server (20) executing a step of extracting user history data (420) from the database in the client's data application layer and a step of verifying user characteristics and lists (430).

If the verification process performed by the core banking determines that the client does not have valid characteristics for the request, the server (40) executes a stage of displaying an error message (440) according to the cause in the Transversal Sales Module (TSM) and the process is terminated, but if the client has valid characteristics for the request, the server (40) executes a stage of displaying the characteristics and benefits of the credit (450) in the Transversal Sales Module (TSM) and proceeds to the next process which is to simulate the credit (500).

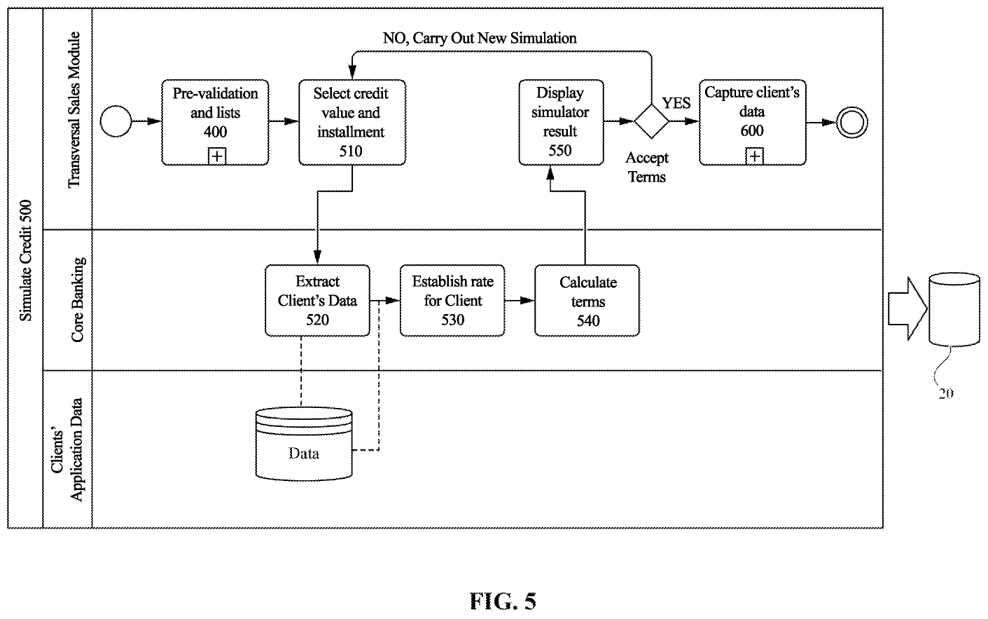

FIG. 5 shows the process of simulating credit (500). In this step, the client can indicate the characteristics of the loan he/she wants and learn about aspects such as the interest rate and the monthly payment.

After the pre-validation, filters and lists (400) explained above, the server (40) executes a stage of displaying the credit options (510) in the Transversal Sales Module (TSM) for the user to select the amount and term.

The core banking may call or fetch data from an external database of a Bank server (20) which extracts the client's data (520), sets the rate for the client (530) and calculates the conditions (540).

The results of this simulation are presented to the user in stage (550). If the client does not accept these conditions, a new simulation is performed repeating the previous steps (510 to 550), but, if the user accepts the conditions of the credit simulation, we proceed to the next process, the capture of the client's data (600).

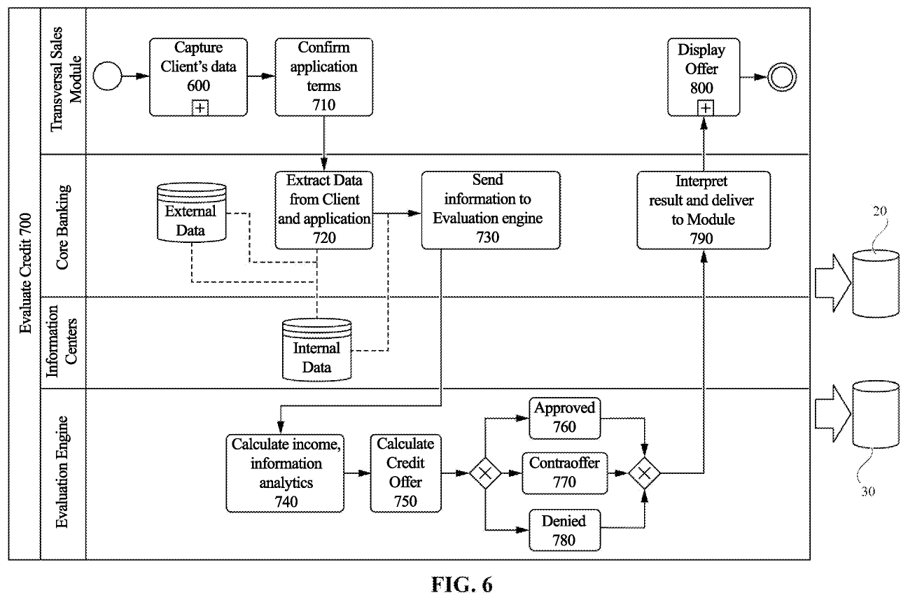

FIG. 6 shows the credit scoring process (700). In this process, the viability of the credit application is reviewed and the formal offer is made with regard to the client's simulated value. Internal and external sources of information are used to determine the approved value, in this case servers (20, 30).

When you have finished capturing the client's data (600), you confirm the conditions of the request (710).

The core banking can call or fetch data from an external database of a Bank server (20) which extracts internal client's data and the request (720), both from internal and external sources (external data external server (30)), and sends the information to the scoring engine (730).

The scoring engine calculates the income, performs the information analysis (740) and calculates the credit offer (750). In this case, there are three possible outcomes: the credit offer is approved (760), a counteroffer is submitted (770), or the offer is denied (780).

The core banking interprets the result delivered by the scoring engine and delivers it to the Transversal Sales Module (TSM) (790), so that the offer is subsequently submitted (800).

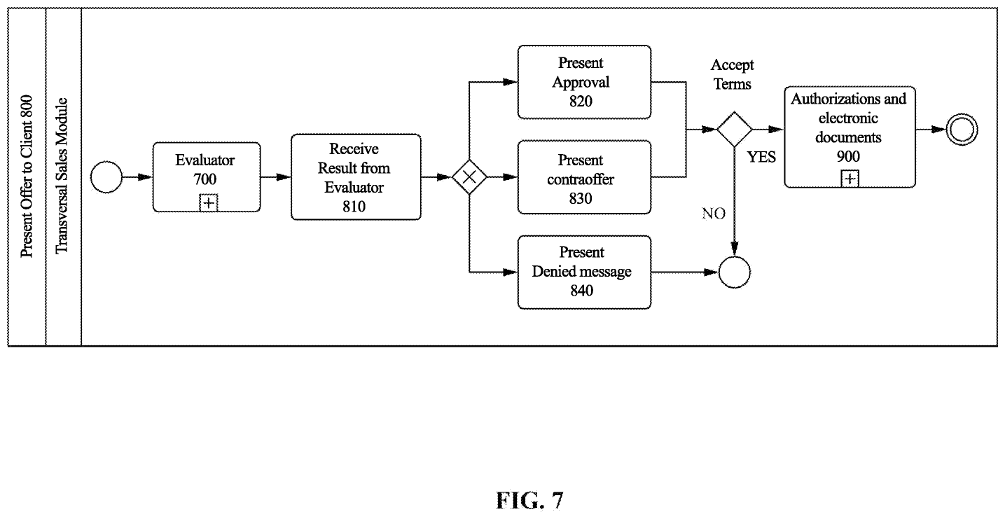

In FIG. 7, the process of presenting the offer to the client (800) is shown, in which the offer is presented as evaluated by the scoring engine in the process (700).

The Transversal Sales Module (TSM) receives the result of the scoring engine (810) and, according to it, presents the approval message (820), presents a counteroffer (830) or shows the denial message (840). When the Transversal Sales Module (TSM) presents the denial message (840) the process ends. In the first two cases (820, 830), if the user accepts the conditions, the electronic authorizations and documents (900) are processed. Otherwise, the process ends.

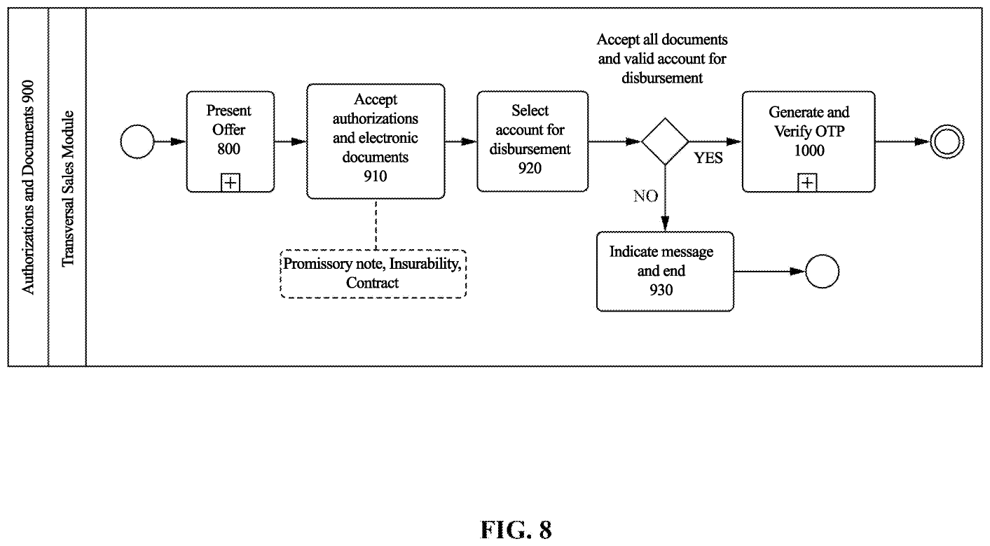

FIG. 8 shows the process of authorizations and documents (900). In this process (900) the client accepts the documents and authorizations required in the credit application; these documents are electronic and do not require paper or photographs.

The Transversal Sales Module (TSM) displays the required documents, such as promissory notes, insurability, contract, for the user to accept the authorizations and electronic documents (910), then it displays the options for the user to select the account for disbursement (920).

If the user does not accept all documents and selects a valid account for disbursement, the Transversal Sales Module (TSM) displays the error message and ends the process (930).

When the user accepts all documents and selects a valid account for disbursement, the system proceeds to generate and verify an OTP (One Time Password) (1000).

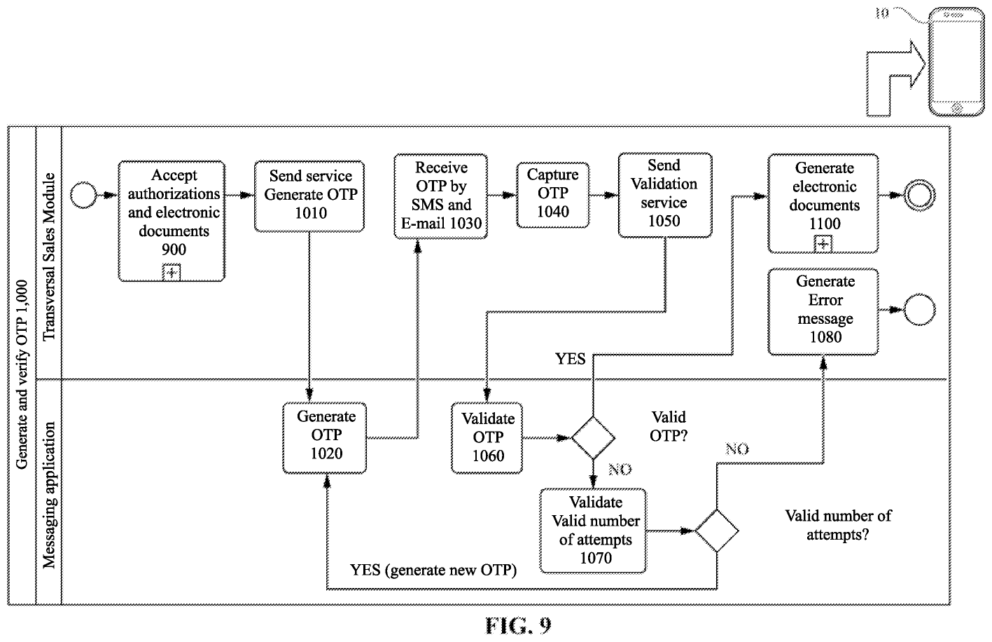

FIG. 9 shows the process of generating and verifying OTP (1000). An OTP is used as the second means of authentication after use of the client's personal key.

The OTP is sent to the client via SMS and e-mail. The Transversal Sales Module (TSM) sends the OTP generation service (1010) to the messaging application that generates the OTP (1020) and sends the generated OTP to the user by SMS and e-mail (1030) (this is sent to the electronic device (10)).

After the client enters the OTP, the Transversal Sales Module (TSM) captures the OTP (1040) and sends the OTP validation service (1050). The messaging application validates the OTP (1060).

If the OTP is not valid, the messaging application validates the number of valid attempts (1070) and if this value has been exceeded, the Transversal Sales Module (TSM) generates an error message (1080) and ends the process. When the number of attempts is valid, a new OTP (1020) is generated and the process is repeated. When the OTP is valid, the electronic documents are generated (1100).

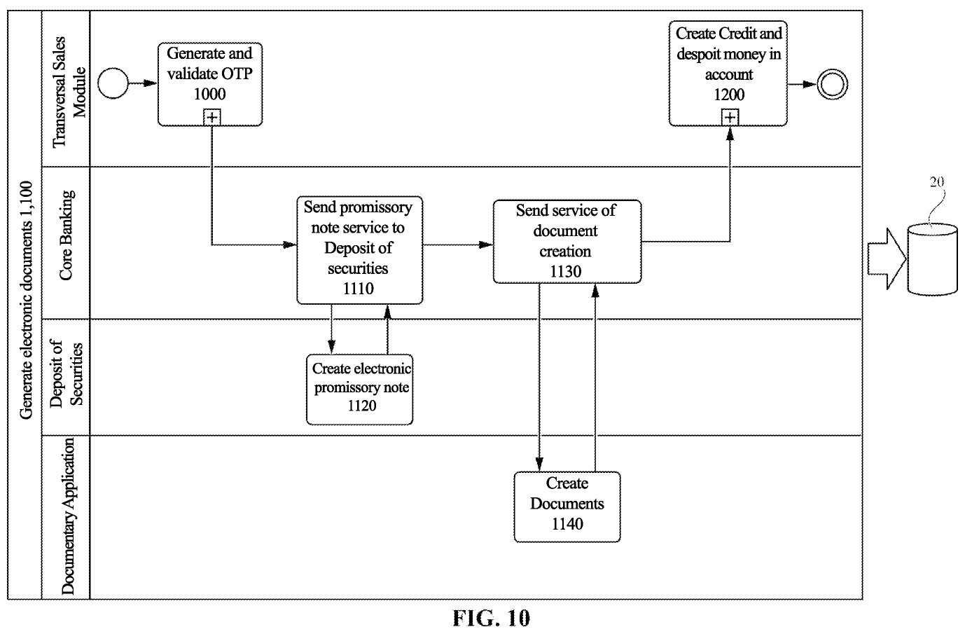

FIG. 10 shows the process of generating electronic documents (1100). In this process, the electronic documents that the client accepted in the authorization screen are generated, prior to the OTP.

These documents are stored in a digital file as a support of the given acceptances. The core banking may bring data from an external database of a Bank server (20) which sends the promissory note service to the securities deposit (1110) and the document creation service (1130) to the document application.

The securities deposit creates the electronic promissory note (1120) and sends it to the core banking. The document application creates the documents (1140) and sends them to the core banking.

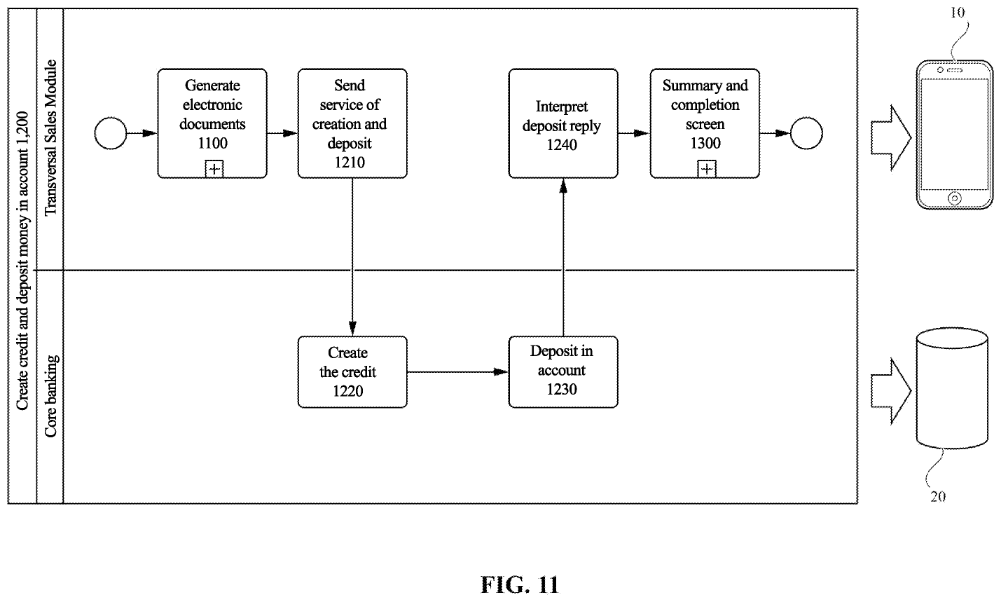

FIG. 11 illustrates the process of creating credit and depositing money into account (1200).

This last stage constitutes the credit creation and disbursement process. After generating the electronic documents (1100), the Transversal Sales Module (TSM) sends the creation and deposit service (1210) to the core banking, the core banking can bring data from an external database from a Bank server (20) which creates the credit (1220) and makes the deposit in the account (1230).

The Transversal Sales Module (TSM) interprets the deposit response (1240) and proceeds to display the summary and completion screen (1300) on the electronic device (10).

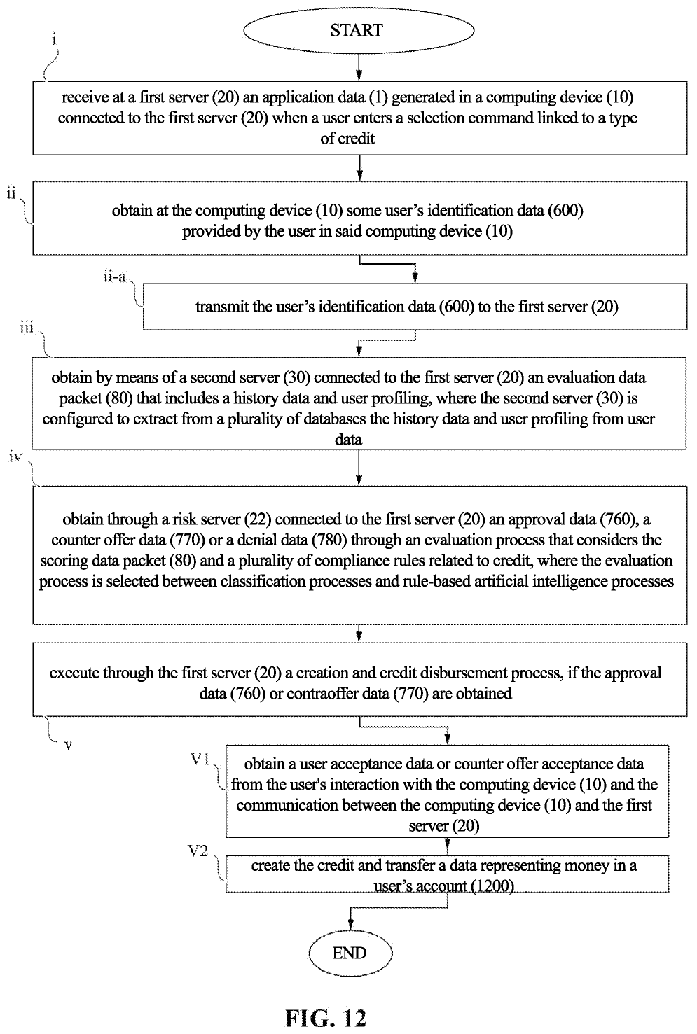

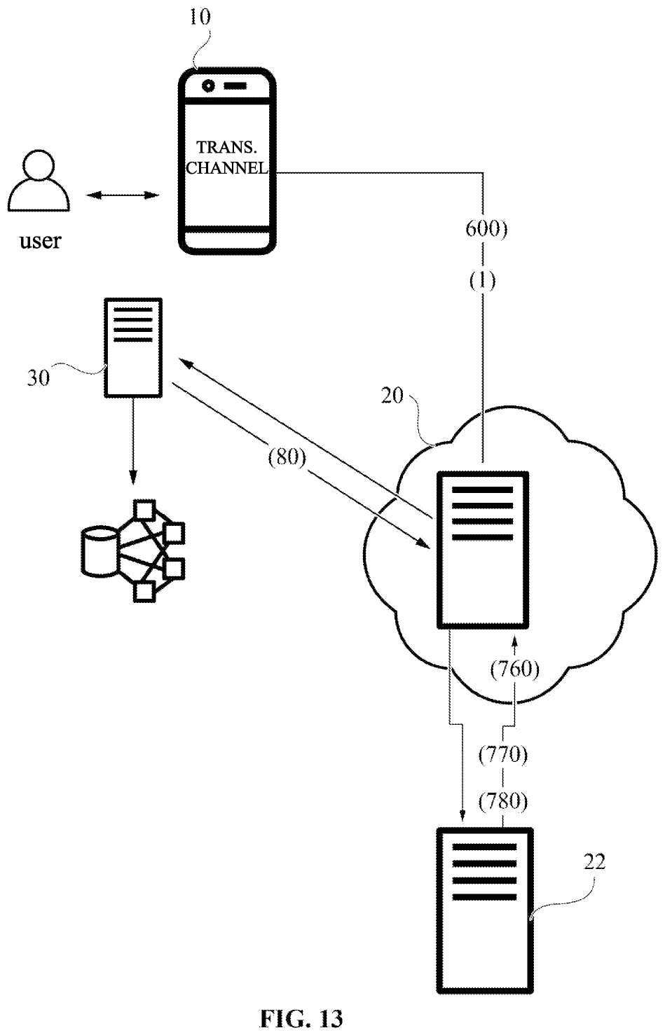

On the other hand, referring to FIG. 12, and FIG. 13, in one embodiment of the invention, the method of approving and disbursing a credit (2000) comprises a stage i) of receiving at a first server (20) a request data (1) generated on a computing device (10) connected to the first server (20) when a user enters a selection command associated with a type of credit.

In this embodiment, the method further comprises a stage ii) of obtaining on the computing device (10) a user identification data (600) provided by the user on said computing device (10) and a sub-stage ii-a) of transmitting the user identification data (600) to the first server (20).

Also, in this embodiment, the method further comprises a stage iii) of obtaining via a second server (30) connected to the first server (20) a scoring data packet (80) comprising a user history and profiling data, wherein the second server (30) is configured to extract from one or more databases the user history and profiling data from the user data of the previous stage (stage ii).

Additionally, in this embodiment, the method has a stage iv) of obtaining via a risk server (22) connected to the first server (20) an approval data (760), a counteroffer data (770) or a denial data (780) via a scoring process that takes as input the scoring data packet (80) and one or more credit-related compliance rules, wherein the scoring process is selected between classification processes and rule-based artificial intelligence processes.

Moreover, in this embodiment the method has a stage v) of executing by means of the first server (20) a credit creation and disbursement process if the approval data (760) or the counteroffer data (770) is obtained.

The process of creating and disbursing credit includes a sub-stage V1) of obtaining a user acceptance data or counteroffer acceptance data from user interaction with the computing device (10) and communication between the computing device (10) and the first server (20). Furthermore, the process of creating and disbursing credit has a sub-stage V2) of creating credit and transferring a data representing money to an account (90) of the user (1200).

One of the advantages of this method embodiment in this invention is that the scoring process executed by the risk server (22) obtains counteroffer data (770) in the event that the user has selected a type of credit that he cannot access, when entering the selection command, but may access a different type of credit, e.g., one with a lower total loan value or with a longer term.

For example, the scoring process may be a rule-based classification process or rule-based artificial intelligence processes that upon identifying in a tree or set of rules that a preset minimum score is not achieved, after processing the scoring data packet (80), then begins to run a branch or set of rules for another type of credit. If in the other type of credit, a score higher than a predefined minimum score is obtained, then the scoring process obtains the counteroffer data (770) in the output.

This prevents the user from having to repeat the process from the beginning, selecting another type of credit or changing the conditions of credit installment and value until the user can obtain the credit needed. This implies a reduction in the load on the servers (20, 30) and a reduction of data traffic in the communication networks, e.g., the Internet, since the interaction between the computing device (10) and the server (20) decreases.

In addition, obtaining the counteroffer data (770) has the advantage that the user can be counteroffered a loan that he or she may not have considered. For example, the user may have applied for a free investment loan without sufficient qualifications, e.g., because he or she does not have an open-ended contract, or his/her age is below a predetermined age, but credit card access is allowed.

In any embodiment of this invention, in which stage v) and its sub-stages V1) and V2) are executed, in sub-stage V2) the user acceptance data and the counteroffer acceptance data may be obtained via the first server (20), or via a server connected to the first server (20), by a selection detection process that takes as input an acceptance command, or counteroffer acceptance command that the user enters into said computing device (10) in response to an approval message (820) or counteroffer message (830) respectively. The first server (20) sends the approval message (820) or counteroffer message (830) to the computing device (10) after stage iv).

Optionally, in any embodiment of this invention in which stage v) and its sub-stages V1) and V2) are executed, the first server (20) may send a data or instruction to the computing device (10) which when processed by a computing unit of said computing device (10) obtains the approval message (820) or counteroffer message (830), which is displayed on a display device of said computing device (10) for the user to receive it.

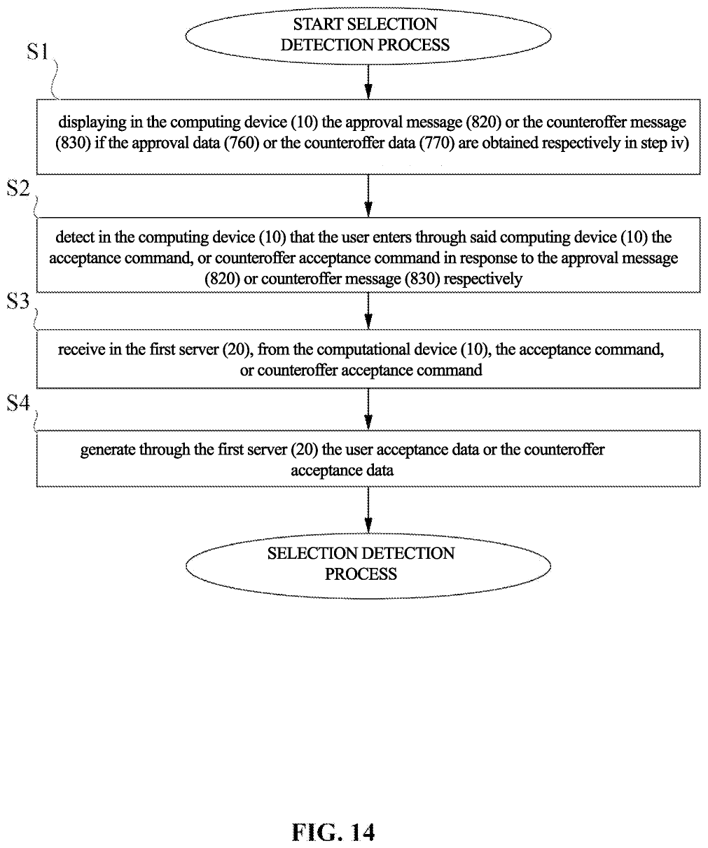

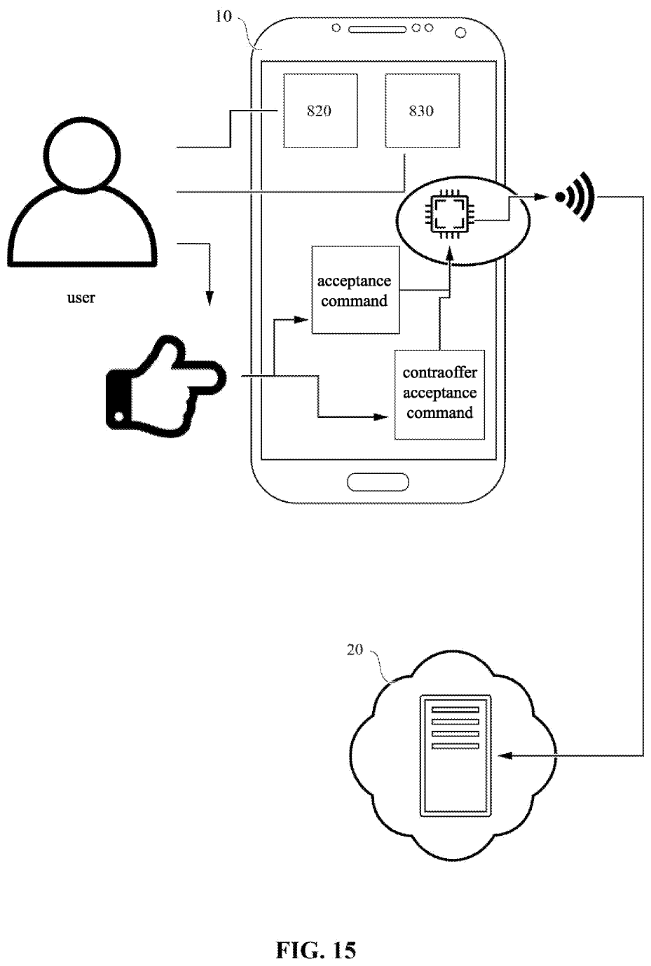

Referring to FIG. 14 and FIG. 15, in some embodiments of the invention, the selection detection process may include a sub-stage Si) of displaying on the computing device (10) the approval message (820) or the counteroffer message (830) if the approval data (760) or the counteroffer data (770) respectively are obtained in stage iv). Subsequently, the selection detection process may include a sub-stage S2) of detecting at the computing device (10) that the user enters via the said computing device (10) a user input at the Human Interface Device (HID) of the computing device (10) from which the computing unit of the computing device (10) generates the acceptance command, or counteroffer acceptance command in response to the approval message (820) or counteroffer message (830) respectively.

Furthermore, the selection detection process may include a sub-stage S3) of receiving at the first server (20), from the computing device (10), the acceptance command, or counteroffer acceptance command; and a sub-stage S4) of generating via the first server (20) the user acceptance data or the counteroffer acceptance data.

In some embodiments of the selection detection process, the first server (20) may send to the computing device (10) data or instructions for the computing device (10) to generate a conditional loop in its computing unit, such as a “for”, “if” or “where” loop, wherein the approval message (820) or the counteroffer message (830) is displayed on the display device of the computing device (10), and when user input is detected when the user interacts with the Human Interface Device (HID) of said computing device (10), then the acceptance command, or counteroffer acceptance command is generated. Then, the computing device (10) sends the acceptance command, or counteroffer acceptance command to the first server (20).

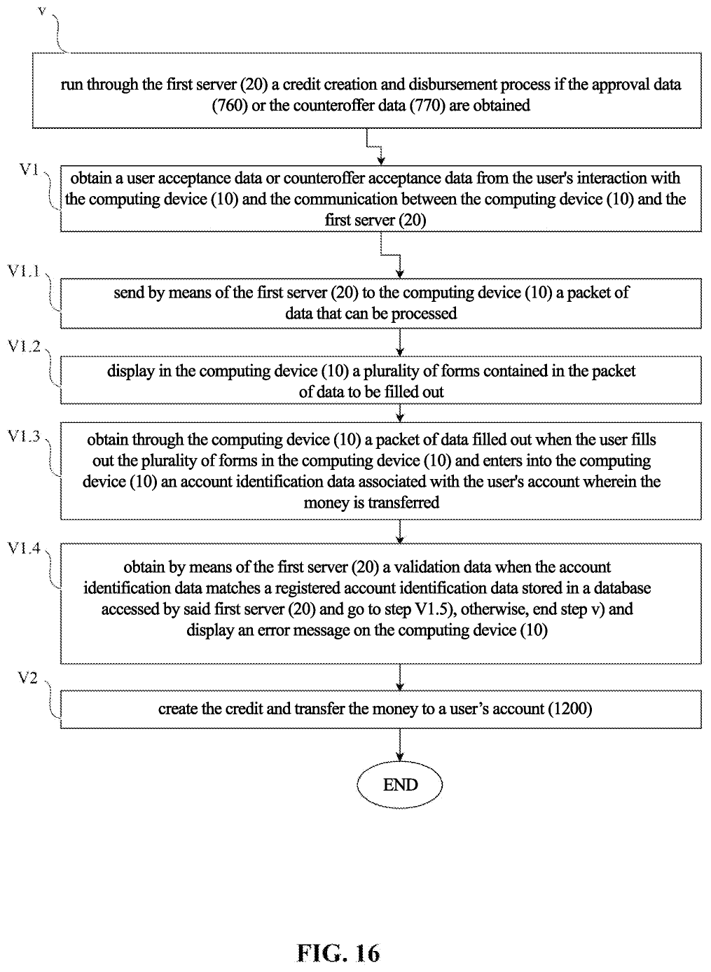

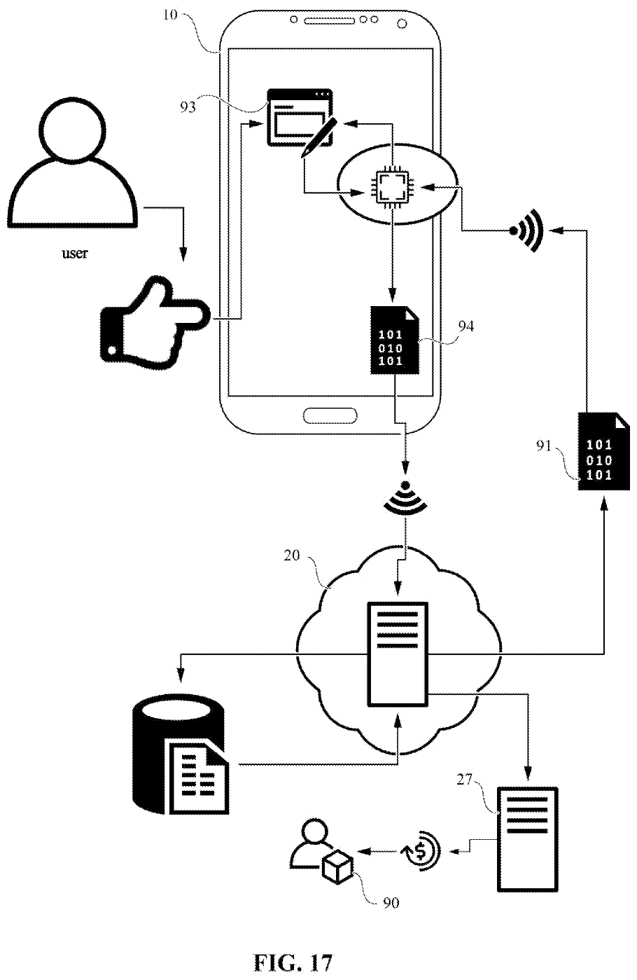

Referring to FIG. 16 and FIG. 17, in any embodiment of this invention in which stage v) is executed, said stage v) may have a sub-stage V1.1) of sending via the first server (20) to the computing device (10) a fillable data packet (91); and a sub-stage V1.2) of displaying on the computing device (10) a form (93), or a plurality of forms (93) contained in the fillable data packet (91).

Furthermore, stage v) may have a sub-stage V1.3) of obtaining by the computing device (10) a completed data packet (92) when the user fills out the form (93) or forms (93) in the computing device (10) and enters into the computing device (10) an account identification data associated with the account (90) of the user wherein the data representing money is transferred.

Similarly, stage v) may have a sub-stage V1.4) of obtaining via the first server (20) a validation data when the account identification data matches a registered account identification data stored in a database accessed by said first server (20) and proceeding to sub-stage V1.5), otherwise terminating stage v) and displaying on the computing device (10) an error message.

In sub-stage V1.5) a transfer authorization data is obtained by the first server (20) from the validation data and the account identification data, wherein the transfer authorization data is sent to a transfer server (27) configured to transfer money to the user's account (90) upon receipt of the transfer authorization data.

According to the above, from sub-stages V1.1) to V1.5) it is possible to identify and verify if the user has a valid account into which the money is transferred at the end of the method.

Optionally, before sub-stage V1.5), the method may have in some embodiments a stage 0 of executing via the first server (20) a user identity verification process comprising a sub-stage F1 of sending from the first server (20) a request to an identification server (24); and a sub-stage F2) of obtaining via the identification server (24) an identification data packet comprising an OTP key data when the request is received.

Moreover, stage f) may further comprise a sub-stage F3) of sending the identification data packet to a user address that is selected from a phone number, e-mail address, social network profile address, and combinations thereof; and a sub-stage F4) of obtaining at the computing device (10) an OTP input data that is entered by the user at the computing device (10) after receiving the identification data packet.

Stage f) may comprise a sub-stage F5) of sending from the computing device (10) to the first server (20) the OTP input data; and a sub-stage F6) of obtaining an OTP validation data when the OTP input data matches the OTP key data and proceeding to stage V1.5), otherwise repeating sub-stages F2) to F5).

In some embodiments of the invention, the request of sub-stage F1) is a web service request. Accordingly, in these embodiments, the first server (20) and the identification server (24) establish a web service communication protocol. In this way, the identification server (24) executes a web service of generation, sending and authentication of provisional one-time passwords or also called OTP (One Time Password) in which one or more of the sub-stages F2 to F6 are executed. This web service can be any of those known by a person moderately skilled in the art.

In embodiments of the invention in which stage f) and its sub-stages F1 to F6) are executed, sub-stage F6) may include a counting process executed by the identification server (24) that increments a counter by one unit each time stages F2) to F5) are executed, wherein when the counter reaches a predetermined value, sub-stage F6) ends and an error message is displayed on the computing device (10). This has the advantage of preventing a bot or virtual machine, or a different user, from making fraudulent attempts to obtain the OTP input data matching the OTP key data.

In any embodiment of the invention, in which sub-stages V1.1) to V1.5) are executed, the method may have a sub-stage V1.6) of obtaining via the first server (20) an issued credit data (1220) and a disbursement confirmation data (1230). The disbursement confirmation data (1230) is generated in the transfer server (27) when the transfer server (27) detects that the user receives the money in his account (90). The issued credit data (1220) is generated in the first server (20) when the transfer authorization data is obtained.

It will be understood in this invention by receiving money in a user account (90), or receiving a data representing money in a user account (90), that a data transfer was made by the transfer server (27) towards a node of a banking network representing the user account (90). The node may have a label with an account number of the account (90), or any other data that allows identifying the node from other nodes, and associating said node to the account (90) of the user.

In any embodiment of the invention in which stage i) is performed, the method may further comprise a stage a) prior to stage i) of obtaining a user authentication data from a user identification process comprising a sub-stage A1) of obtaining a user identity data from a user input entered by the user into the computing device (10). The user input may be selected from words, numbers, characters, patterns or biometric inputs and combinations thereof, or any other input that may identify a user that is known to a person reasonably skilled in the art.

Moreover, the user identification process includes a sub-stage A2) of obtaining through the first server (20) a user authentication data by a comparison process that takes as input the user identity data and a registered identity data associated with a user profile data packet, and verifies whether the user identity data matches the registered identity data. The registered identity data and the user profile data packet are stored in a database configured to be queried by the first server (20).

Also, the user identification process includes a sub-stage A3) of proceeding to stage i) if the identity data matches the registered identity data, otherwise, if the identity data does not match the registered identity data, then an error message is displayed on the computing device (10) and sub-stages A1) to A3) are repeated.

In this way, the method identifies and authenticates the login of an authorized user.

Similarly, the identification process can be any other method of user authentication known to a person reasonably skilled in the art.

In any embodiment of the invention in which stage i) is performed, the method may further comprise a sub-stage B) prior to stage ii) of executing on a firewall (25) connected to inputs of the first server (20) receiving data from the computing device (10), second server (30) and the risk server (22), a pre-validation process and security filters (400) configured to establish a secure connection between the first server (20), second server (30), the risk server (22) and the computing device (10).

In any embodiment of the invention in which stage a) is executed, between stages a) and ii) a stage of verifying some user characteristics and scoring lists (430) may be executed through the first server (20) by means of a verification process.

The verification process may include a stage of querying through the first server (20) one or more security databases to determine from the user profile data packet whether there is a rule violation data associated with the user. If the rule violation data is found in a database, then the first server (20) executes a stage of ending the method, otherwise, the verification process ends and goes to stage iii).

One of the advantages of the verification process is to identify from the user's credit application, if the user is reported on any scoring lists where the user has a negative financial or legal history.

In any embodiment of the invention in which stage iii) is executed, the method in this invention may include before stage iii) a sub-stage B) of executing through the first server (20) a selection process configured to obtain at least one credit terms data.

The selection process may have a sub-stage B1) of displaying on the computing device (10) a message of credit value and installment selection (510); and a sub-stage B2) of receiving on the first server (20) a value and installment selection data generated by the computing device (10) when the user enters via said computing device (10) a value and installment selection command, in response to the message of value and installment selection.

Moreover, the selection process may have a sub-stage B3) of executing through the first server (20) a mathematical model having as input the value and installment selection data and obtaining as output the at least one credit terms data; and a sub-stage B4) of displaying on the computing device (10) a credit value and installment result message generated by the first server (20) considering the credit terms data.

Also, the selection process may have a sub-stage B5) of receiving at the first server (20) an acceptance data generated by the computing device (10) if the user selects by said computing device (10) a value and installment value acceptance command in response to the credit value and installment value results message and proceeding to stage iii).

Moreover, the selection process may have a sub-stage B6) of receiving at the first server (20) a denial data, if the user selects by said computing device (10) a value and installment rejection command in response to the credit value and installment results message and proceed to sub-stage B1).

One of the advantages of the selection process is to be able to inform the user about the conditions of the loan he/she wants to obtain, e.g., the monthly payment, interest rate, amortization tables, total interest, and other information that allows the user to understand the details of the loan he/she wants to obtain. This is important, e.g., in jurisdictions where legal regulations require that the entities offering financial products transparently explain to the consumer, e.g., the user, all the loan conditions, especially the costs that he or she will have to pay during the time it takes to repay the loan.

Optionally, at least one credit terms data is stored in a database to which the user has access, e.g., through a website or mobile application (APP) of the entity granting the credit. This allows to reduce the processing capacity of the first server (20) in case the user, after having received the credit, wants to consult again the credit terms, which are contained in the at least one credit terms data.

In some of these embodiments of the method, prior to sub-stage B3) the first server 20) may run a stage of obtaining a rate data in a database from the user profile data packet, and wherein in sub-stage B3) the mathematical model takes as input the rate data to calculate the at least one credit terms data. This step is important when the lender defines classes of users, where different rates are granted according to the user's ability to pay, age, type of employment contract, amount of property owned, monthly income, income-to-debt ratio, and similar factors known to a person reasonably skilled in the art.

On the other hand, this invention relates to a credit approval and disbursement system (2000) configured to perform stages of any of the method embodiments of the invention previously described in this disclosure.

In one invention embodiment of the system of the invention, the system comprises a first server (20) establishing connection with a computing device (10), a second server (30) connected to the first server (20), a risk server (22) connected to the first server (20), wherein the first server (20) is connected to the second server (30), the risk server (22) and the computing device (10) via a computer network.

The first server (20) has a processing module configured to establish connection with a computing device (10). Also, the first server (20) may be configured to receive a request data (1) generated at the computing device (10) when a user enters a selection command associated with a type of credit; and receive from the computing device (10) a user identification data (600) provided by the user at said computing device (10).

Moreover, the first server (20) may be configured to run a credit creation and disbursement process from an approval data (760) or counteroffer data (770). The credit creation and disbursement process include obtaining a user acceptance data or counteroffer acceptance data from user interaction with the computing device (10) and communication between the computing device (10) and the first server (20); and creating credit and transferring the data representing money to an account (90) of the user (1200).

The second server (30) has a processing module configured to obtain a scoring data packet (80) comprising a user history and profiling data. The second server (30) is configured to extract from a plurality of databases the user history and profiling data from the user data of the previous stage.

The risk server (22) has a processing module configured to obtain the approval data (760), the counteroffer data (770), or the denial data (780) by a scoring process that takes as input the scoring data packet (80) and a plurality of credit-related compliance rules. The scoring process is selected between classification processes and rule-based artificial intelligence processes.

In the computing network connecting the first server (20) with the second server (30), the risk server (22) and the computing device (10), the request data (1), user identification data (600), approval data (760), counteroffer data (770), user acceptance data, counteroffer acceptance data, scoring data packet (80), history data and user profiling are exchanged.

In any embodiment of the system in this invention, the system may include a Transversal Sales Module (TSM) configured to establish the connection between the first server (20) and the computing device (10).

For example, the Transversal Sales Module (TSM) may have a presentation layer configured to display messages and user screens on the computing device (10) and capture commands and data that the user enters into his/her computing device (10); and an application layer configured to establish a communication protocol with the first server (20). The communication protocol may be selected from HTTPS, SOAP, or REST, or any other communication protocol known to a person reasonably skilled in the art.

In these embodiments of the system in this invention, where there is the Transversal Sales

Module (TSM), the first server (20) forms a web service architecture with at least the second server (30), the risk server (22) and the computing device (10). Other servers may be connected to the first server (20), e.g., a transfer server (27), an identification server (24), a security server (25), a server configured to manage a web page or APP that is configured to establish communication between the first server (20) and the computing device (10), and any other type of server that can send web service requests to the first server (20) or that can receive web service requests from the first server (20) and respond with data associated with a request.

The Transversal Sales Module (TSM) may be a software module, e.g., a process, method, web application, mobile application (APP) or API managed by a communication server (40) that can process data being sent to and received by the first server (20), e.g., by identifying or generating identification tags that can relate a data or data packet to the server (20, 22, 24, 30, 40) or computing device (10) receiving or sending such data or data packet.

In several embodiments of the method and system in this invention involving a Transversal Vending Module (TSM), the Transversal Vending Module (TSM) may be integrated with a software program or mobile application (APP) that is accessed by the computing device (10) and that is configured to interact with the computing device (10) by sending and receiving data, tags and commands. The computing device (10) may have the software program or mobile application (APP) installed in a memory module, or may access the software program or mobile application (APP) via a communication network, e.g., the internet, when the software program or mobile application (APP) is a progressive web Application.

For example, the Transversal Sales Module (TSM) can be an application programming interface (API) integrated to the software program or mobile application (APP).

In any embodiment of the system having a web service architecture the first server (20) may be configured as a broker type server, where the connections from the first server (20), the second server (30), the risk server (22) establish a communication protocol selected from HTTPS, SOAP, or REST.

It will be understood that in specific embodiments of the method in this invention, where the intervention of a server, computing device, or web services server other than those mentioned above is required, these additional servers may be connected to the first server (20), or to any server (22, 25, 30, 40) that is connected to the first server (20) and can route data sending and receiving communication to and from the first server (20).

On the other hand, this invention also relates to a computer program comprising instructions, which when the program is executed in a system according to any of the aforementioned embodiments, cause said system to carry out the stages of a method according to any embodiment of the methods previously described in this disclosure.

For example, the computer program may be divided into fragments that are stored in executable or installable data packets that may be executed and optionally installed on the computing device (10) and on at least the first server (20), a second server (30), and a risk server (22). For each computing device (10) or server (20, 22, 30) a different executable or installable data packet may be used.

The computer program can be written in any programming language known to a person moderately skilled in the art. For example, the computer program can be written in Java, Javascript, Perl, PHP and C++, #C, Python, SQL, Swift, Ruby, Delphi, Visual Basic, D, HTML, HTMLS, CSS, and other programming languages known to a person moderately skilled in the art.

In some embodiments of the invention, the installable or executable data packets may be programmed in different programming languages, according to which a computing device (10) or server (20, 30, 22, 25, 40) is used.

For example, the installable or programmable data packet for one computing device (10) may be written in Java or HTML, while for a second server (30) it may be written in Python. Similarly, the servers accessing databases run or install an installable or programmable data packet written in a programming language selected from SQL and PHP.

When the computer program or fragment thereof is installed on the computing device (10) or on a server (20, 30, 22, 25, 27, 40), the computer program or fragment thereof may be stored in a memory module, wherein the computing unit of said computing device (10) or server (20, 30, 22, 25, 27, 40) reads the program, or fragment thereof.

On the other hand, this invention also relates to a computer-readable medium comprising instructions, which when the program is executed in a system according to any of the aforementioned embodiments, cause said system to carry out the stages of a method according to any embodiment of the methods previously described in this disclosure.

The computer readable media can be selected from executable files, installable files, compact disks, RAM memory (cache memory, SRAM, DRAM, DDR), ROM memory (Flash, Cache, hard disks, SSD, EPROM, EEPROM, removable ROM memory (e.g., SD (miniSD, microSD, etc.), MMC (MultiMedia Card), Compact Flash, SMC (Smart Media

Card), SDC (Secure Digital Card), MS (Memory Stick), among others)), CD-ROM, Digital Versatile Disc (DVD) or other optical storage, magnetic cassettes, magnetic tapes, storage or any other media that can be used to store information and can be accessed by a processing unit.

The computer-readable medium may be a set of computer-readable elements into which instructions are divided or fragmented that when executed by one or more servers or computing devices (10) allow for carrying out the steps, stages, sub-stages of a method according to any embodiment of the methods previously described in this disclosure. The division or fragmentation of the steps, stages, sub-stages allow the server (20, 30, 22, 25, 27, 40) or computing device (10) reading the instructions from the computer-readable medium to specifically run the steps, stages, sub-stages corresponding thereof, within a method in accordance with any embodiment of the methods previously described in this disclosure.

### EXAMPLE 1

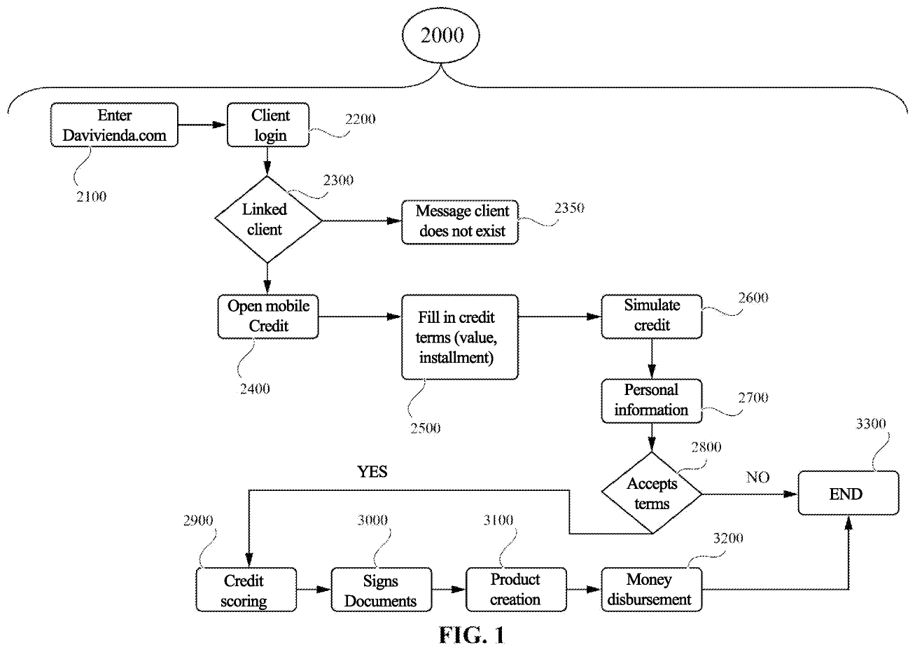

Referring to FIG. 1, in an example of the invention, the system and method include validation, authentication, comparison, and risk score generation in a short period of time, using an electronic processing device. Moreover, the system and method of this example executes the application, creation and disbursement of a credit. Preferably, the execution of the method, from start to finish, takes approximately five (5) minutes.

The user enters the website or mobile application of the bank (2100) or entity authorized to issue loans or credits to users, which for illustrative purposes is Davivienda.com, and enters the platform with their identification credentials (2200). The system verifies the data entered by the user and determines whether or not he/she is a client of the corresponding bank (2300). If the system determines that the client is not linked, a message is displayed to the user indicating that the client does not exist (2350).

If the data corresponds to a linked client and the user selects the option to open a mobile credit (2400), a form will be displayed for the user to fill in the credit terms, such as the amount requested and select the desired installment to pay (2500).

The system performs the credit simulation (2600) and asks the user for personal information (2700). The system performs a process in which the viability of the credit application is reviewed and the formal offer is made with regard to what was simulated by the client. The result of this process is presented to the user (2800).

The system (2000) performs a process in which the viability of the credit application is reviewed and a formal offer is made with regard to what the client has simulated. The result of this process is presented to the user (2800). If the user does not accept the conditions made by the system (2000), the process ends (3300).

If the user does not accept the conditions made by the system, the process ends (3300). If the user accepts the conditions set by the system, the credit scoring is carried out (2900), the electronic documents are generated for the user to sign (3000), the product is created (3100) and the money is disbursed to the account selected by the user (3200). After the disbursement of the money (3200), the process ends (3300).

### EXAMPLE 2

A second example of the system in this invention is described below.

Referring to FIG. 2 and FIG. 3, the system has a core banking (20) that extracts the client's data (220) upon entering the financial institution's computer channel and performs a password verification (230). If the password is incorrect, an error message is displayed (240). When the entry data is verified correctly, the home page with the characteristics and benefits is displayed (250).

Referring to FIG. 4, the system has a Transversal Sales Module (TSM) that sends client's data to the core banking (410). The core banking extracts the client's data (420) from the database in the client's data application layer and performs verification of the client characteristics and lists (430). If the verification process performed by the core banking determines that the client does not have valid characteristics for the request, the Transversal Sales Module (TSM) presents the error message according to the cause (440) and ends the process. When the client has valid characteristics for the application, the

Transversal Sales Module (TSM) presents the characteristics and benefits of the product (450).

Referring to FIG. 5, the Transversal Sales Module (TSM) displays the options for the user to select the credit value and installment (510). The core banking (20) extracts the client's data (520), sets the rate for the client (530), and calculates the installment (540). The results of this simulation are presented to the user (550). If the client does not accept these conditions, a new simulation is carried out repeating this process (510 to 550). When the user accepts the conditions of the credit simulation, the client's data is captured (600).

Referring to FIG. 6, the system checks for confirmation of the request conditions (710) by the user. The core banking (20) extracts client and application data (720), from both internal and external sources, and sends the information to the scoring engine (730). The scoring engine calculates the income, analyzes the information (740) and calculates the credit offer (750). In this case, there can be three possible outcomes, that the credit offer is approved (760), that a counteroffer is submitted (770) or that the offer is denied (760). The core banking (20) interprets the result delivered by the scoring engine and delivers it to the Transversal Sales Module (TSM) (750).

Referring to FIG. 7, the Transversal Sales Module (TSM) receives the result of the scoring engine (810) and, accordingly, presents the pass (820), the counteroffer (830) or the denial message (840). When the Transversal Sales Module (TSM) presents the denial message (840) the process ends. In the first two cases (820, 830), if the user accepts the conditions, the electronic authorizations and documents (900) are processed. Otherwise, the process ends.

Referring to FIG. 8, the Transversal Sales Module (TSM) displays the required documents, such as promissory notes, insurability, contract, for the user to accept the authorizations and electronic documents (910). Then, it displays the options for the user to select the account for disbursement (920). If the user does not accept all documents and select a valid account for disbursement, the Transversal Sales Module (TSM) displays the error message and ends the process (930). When the user accepts all documents and selects a valid account for disbursement, the system proceeds to generate and verify OTP (One Time Password) (1000).

Referring to FIG. 9, the Transversal Sales Module (TSM) sends the generate OTP service (1010) to the messaging application that generates the OTP (1020) and sends the generated OTP to the user by SMS and e-mail (1030). After the client enters the OTP, the

Transversal Sales Module (TSM) captures the OTP (1040) and sends the OTP validation service (1050). The messaging application validates the OTP (1060). If the OTP is not valid, the messaging application validates the number of valid attempts (1070) and if this value has been exceeded, the Transversal Sales Module (TSM) generates an error message (1080) and ends the process. When the number of attempts is valid, a new OTP is generated (1020) and the process is repeated. When the OTP is valid, the electronic documents are generated (1100).

Referring to FIG. 10, the core banking (20) sends the promissory note service to the securities deposit (1110) and the document creation service (1130) to the document application. The securities deposit creates the electronic promissory note (1120) and sends it to the core banking. The document application creates the documents (1140) and sends them to the core banking (20).

Referring to FIG. 11, the Transversal Sales Module (TSM) sends the creation and deposit service (1210) to the core banking (20), which creates the credit (1220) and makes the deposit to the account (1230). The Transversal Sales Module (TSM) interprets the deposit response (1240) and proceeds to display the summary and finalization screen (1300).

### EXAMPLE 3

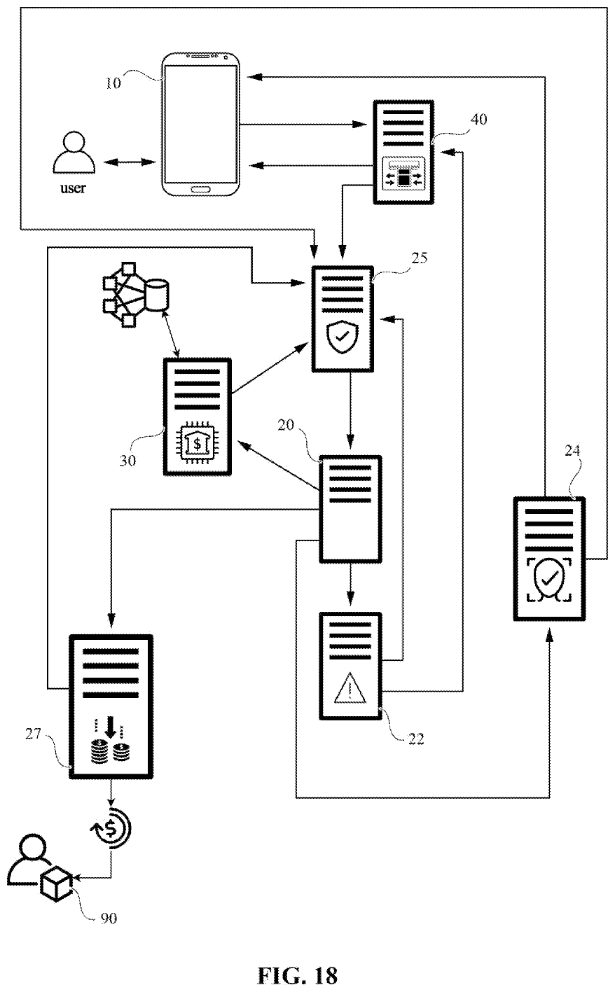

Referring to FIG. 18, in an example in this invention the first server (20) is configured as a broker server of a web service architecture. There is a firewall (25) connected to the inputs of the first server (20) that establishes a secure connection with a communication server (40) and servers (30, 24, 22, 27) of which the first server (20) consumes web services.

The communication server (40) manages a Transversal Sales Module (TSM) that allows communication between the first server (20) and the computing device (10). The computing device (10) accesses a mobile application (APP) in which the Transversal Sales Module (TSM) is integrated. In this case the Transversal Sales Module (TSM) is an API.

In this example, the data, tags and commands exchanged between the computing device (10) and the servers (20, 30, 22, 25, 27, 40), include identification tags that enable identification of the computing device (10) or server (20, 30, 22, 25, 27, 40) issuing the data, tags and commands, and enable identification of the user requesting the credit.

The second server (30) is a banking server or core banking server configured to query a plurality of databases such as governance and security databases, internal databases of the entity that may grant the credit, and consume web services from other servers (not illustrated), e.g., a bureau type server that sends a data packet containing financial information.

From the database queries and web service responses obtained by the second server (30), the second server (30) obtains a scoring data packet (80) which is sent to the first server (20).

The risk server (22) is configured to run a scoring process to obtain an approval data (760), a counteroffer data (770) or a denial data (780) from the scoring data packet (80).

The approval data (760), a counteroffer data (770) or a denial data (780) is sent to the first server (20) via the firewall (25).

If the first server (20) receives a denial data (780) the method ends, and an instruction is sent to the communication server (40) to deploy in the Transversal Sales Module (TSM) application layer, which is embedded in the presentation layer to the APP accessed by the user through the computing device (10), a rejection message ending the process of credit creation and disbursement, and ending the method.

Otherwise, when, an approval data (760) or counteroffer data (770) is obtained, the first server (20) sends to the communication server (40) an instruction to display an approval message (820) or counteroffer message (830).

Referring to FIG. 15, the approval message (820) or counteroffer message (830) is displayed on the display device of the computing device (10), and the user enters an acceptance command or counteroffer acceptance command into the human interface device (HID), which upon processing by the computing unit of the computing device (10) generates a user acceptance data or counteroffer acceptance data.

Referring to FIG. 18, the computing device (10) sends the user acceptance data or counteroffer acceptance data to the first server via the communication server (40) that manages the sales cross-channel. The user acceptance data or counteroffer acceptance data passes through the security server (25) and is finally received by the first server (20). Upon receiving the user acceptance data or counteroffer acceptance data, the first server (20) consumes web services from the second server (30) to create the credit.

The second server (30) creates the credit and records the same in a database.

Subsequently, the second server (30) sends an issued credit data (1220) to the first server (20). Then, the first server (20) consumes web services from a transfer server (27) by sending a transfer authorization data.

Then, the transfer server (27) transfers data to an account (90) of the user, which corresponds to money. When the transfer server (27) completes the transfer it sends to the first server (20) a disbursement confirmation data (1230).

When the first server (20) receives the disbursement confirmation data (1230) the method ends.

Glossary:

The following is a description of some of the terms used in some modalities of the method and system disclosed throughout the Specification:

User or client: The user or client is a person who interacts through a computing device (10) with the first server (20), and other servers connected to the first server (20), to provide instructions, authorizations, or queries that are executed, responded to, or fed back by the first server (20), and from more servers connected to the first server (20).

Computing device (10) or electronic processing device (10): All of those devices in which communication can be established with one or more computing devices (10) and/or servers (20, 30, 40, 22, 24, 27) to exchange data, tags and commands through a communication network. Examples of computing devices (10) are smartphones, tablets, phablets, personal computers, microprocessors provided with internet communication modules and user interfaces, or any element having a processing unit configured to receive instructions from the user via a Human Interface Device (HID) and a display device configured to display messages and information to the user. In addition, the computing device (10) or electronic processing device (10) may include a memory module, a wired communication module, a wireless communication module, and other modules for recording, querying, retrieving, sending, and receiving data, commands, and tags.

Computing unit, processing unit, or processing module: A computing unit, processing unit, or processing module is a device that processes data, e.g., microcontrollers, microprocessors, DSCs (Digital Signal Controllers), FPGAs (Field Programmable Gate Arrays), CPLDs (Complex Programmable Logic Devices), ASICs (Application Specific

Integrated Circuit), SoCs (System on Chip), PSoCs (Programmable System on Chip), computers, servers, tablets, cell phones, smart phones, signal generators and computing units, processing units or processing modules known to the average person in the field and combinations thereof.

Human Interface Device (HID): It will be understood in this invention that a Human Interface Device (HID) can be any device capable of allowing a user to input data into the computing unit of the computing device (10). Examples of Human Interface Devices (HID) include, without limitation, keyboard, mouse, trackball, touchpad, pointing device, joystick, touch screen, microphones coupled to voice recognition and data generation modules, cameras and other image capture devices coupled to gesture recognition and generation modules, among other devices capable of allowing a user to input data into the computing unit of the computing device, and combinations thereof.

Display device: A display device corresponds to any device that can be connected to a computing unit and display its output, it is selected among others from CRT (Cathode Ray Tube) monitor, flat panel display, LCD (Liquid Crystal Display) display, active matrix LCD display, passive matrix LCD display, LED displays, display projectors, TV (4KTV, HDTV, Plasma TV, Smart TV), OLED (Organic Light Emitting Diode) displays,

AMOLED (Active Matrix Organic Light Emitting Diode) displays, QD (Quantum Dot Display) displays, segment displays, among other devices capable of displaying data to a user, known to those skilled in the art, and combinations thereof.

Módulo de comunicaciones: In this invention, communication module will be understood as a hardware element coupled to a computing unit, processing unit, or processing module of a computing device (10) or a server, which allows to establish communication between one or more computing devices (10) or servers to exchange data, commands and/or tags.

For example, the communication module may be selected from the group consisting of wired communication modules, wireless communication modules, and wired and wireless communication modules.

Examples of wireless communication modules are those using a wireless communication technology that is selected from the group consisting of Bluetooth, WiFi, RF ID (Radio

Frequency Identification), UWB (Ultra-Wideband), GPRS, Konnex or KNX, DMX (Digital MultipleX), WiMax and equivalent wireless communication technologies that are known to a person moderately skilled in the field and combinations thereof.

Examples of wired communication modules have a wired connection port that allows communication with external devices via a communication bus, which is selected from the I2C (IIC Inter-Integrated Circuit), CAN (Controller Area Network), Ethernet, SPI (Serial Peripheral Interface), SCI (Serial Communication Interface), QSPI (Quad Serial Peripheral Interface), QSPI (Quad Serial Peripheral Communication Interface), and so on, SPI (Serial Peripheral Interface), SCI (Serial Communication Interface), QSPI (Quad Serial Peripheral Interface), 1-Wire, D2B (Domestic Digital Bus), Profibus and others known to a person moderately skilled in the art, and combinations thereof.

Server: In this invention, a server means a device having a processing unit configured to run a series of instructions corresponding to stages or steps of methods, routines or processes. The server may install and/or run a computer program that may be written in Java, Javascript, Perl, PHP and C++, #C, Python, SQL, Swift, Ruby, Delphi, Visual Basic, D, HTML, HTMLS, CSS, and other programming languages known to a person reasonably skilled in the art.

In addition, the server has a communication module that allows connection to other servers or computing devices.

Additionally, servers can connect to each other, and connect to other computing devices through web service architectures and communicate via communication protocols such as SOAP, REST, HTTP/HTML/TEXT, HMAC, HTTP/S, RPC, SP and other communication protocols known to a person reasonably skilled in the art.

Similarly, the servers mentioned in the Specification of this invention may be interconnected through networks such as the Internet, VPN networks, LANs, WANs, other equivalent or similar networks known to a person reasonably skilled in the art and combinations thereof. These same networks may connect one or more computing devices (10) to one or more servers.

Some of the servers mentioned in the Specification of this invention may be virtual servers or web servers.

Any of the servers in this invention may include a memory module configured to store instructions that run a part, or all, of one or more stages of any method disclosed herein, when executed by the server.

In some embodiments in this invention, one or more of the servers (20, 30, 40, 22, 24, 27) may be physical servers or virtual servers with a backup architecture or clustered architecture, in which one or more replacement servers are configured to ensure high availability.

Memory module: In this invention, a memory module or memory registry shall be understood as a hardware element that includes, but is not limited to, RAM (cache memory, SRAM, DRAM, DDR), ROM memory (Flash, Cache, Hard Disks, SSD, EPROM, EEPROM, removable ROM memories (e.g., SD (miniSD, microSD, etc.), MMC (MultiMedia Card), Compact Flash, SMC (Smart Media Card), SDC (Secure Digital Card), MS (Memory Stick), etc.), among others)), CD-ROM, Digital Versatile

Disc (DVD) or other optical storage, magnetic cassettes, magnetic tapes, storage or any other media that can be used to store information and can be accessed by a computing unit, processing unit, or processing module. Memory modules generally incorporate instructions, data structures, computer program modules. Examples of data structures are: a text sheet or spreadsheet, or a database.

First server (20): In this invention the first server (20) may be configured to execute a plurality of method stages in this invention, or may be configured to receive requests, commands and data from computing device (10) and other servers (30, 40, 22, 24) and send processed, or unprocessed, requests, commands and data to the servers (30, 40, 22, 24), or other servers to run one or more stages thereon of one or more modalities of the method disclosed herein.

In any embodiment of the system in this invention, the first server (20) may have a memory module, or connect to a database, wherein instructions are stored that when run on the first server (20) allow it to run a plurality of stages of any embodiment of the method disclosed herein.

In some embodiments of the system in this invention, the first server (20) is configured as a broker or BUS server configured to communicate with the other servers through a web service architecture. In this case, communication via web services is used, which allows two-way communication between the user's computing device (10) and the services consulted on other servers (30, 40, 22, 24).

In these embodiments, the first server (20) may be configured to translate the data received from the computing device (10) and from other servers (30, 40, 22, 24) from one programming language to a different programming language. This is important in case the computing device (10) and/or the servers (30, 40, 22, 24) are programmed in different programming languages from the one handled by the computing device (10).

In some embodiments of the system in this invention, the first server (20) may be a core-type server or core banking, configured to run database query processes, form data packets, send and receive data and data packets to and from internal servers of the bank, financial institution or credit issuing entity, or external servers where external database queries are executed, or processing of data sent by the first server (20).

Second server (30) or external server (30): In some embodiments of the system and method in this invention, the second server (30) also called external server (30), is a server that may be located at a different location than where the first server (20) is located. For example, the second server (30) may be a server of an external agent, such as a provider of database query services that are not directly accessed by the first server (20).

In several embodiments of the system and method in this invention, the second server (30) is a server of a web services provider, related to user history and profiling data, such as credit scores, credit history, estimated income data of a user, relationship between income and debt capacity, foreclosure histories, collection processes, cancellation of financial products, data related to payment of financial obligations, such as days not in arrears, maximum number of days in arrears. For example, the second server (30) may be a bureau type server, and belong to companies dedicated to provide financial information services, such as Experian-Datacrédito, TransUnion, Equifax, and similar or equivalent companies, platforms or services known to a person reasonably skilled in the art.

In several embodiments of the system and method in this invention, the second server (30) connects to the first server (20) via a web service architecture, wherein the first server (20) sends a request to the second server (30), so that the second server (30) obtains one or more data requested in the request and sends it to the first server (20).

Communication Server (40): In some embodiments of the system and method in this invention, the system may have a communication server (40) that connects between the first server (20) and the computing device (10) by establishing a communication protocol. A Transversal Sales Module (TSM) may be managed by the communication server (40).

The communication server (40) may be configured to send and receive data between the first server (20) and the computing device (10). When transferring data between the first server (20) and the computing device (10), the communication server (40) may process the data being sent and received, e.g., by identifying or generating identification tags that can relate a data or data packet to the server (20, 22, 24, 30, 40) or computing device (10) receiving or sending such data or data packet.

Risk server (22): In some embodiments of the system and method in this invention, the system may have a risk server (22) connected to the first server (20). The risk server (22) may have a memory module and a processing unit that executes instructions stored in the memory module, in order to run one or more stages of one or more embodiments of the method disclosed herein.

For example, the risk server (22) may have in its memory module a scoring process that takes a scoring data packet (80) as input and a plurality of credit-related compliance rules, where the scoring process is selected between classification processes and rule-based artificial intelligence processes.

In some embodiments of the system and method in this invention, the risk server (22) may be connected to other servers in order to obtain data, which is processed in the scoring process.

In some embodiments of the system and method in this invention, the risk server (22) is connected to a terminal configured for an administrating user to enter or modify rules of the scoring process.

The rules of the scoring process may be based on comparison of data included in the scoring data packet (80) with predetermined rule compliance data. For example, in the scoring data packet (80) there may be a monthly net income data, which the first server (20) obtains by sending a request to the second server (30), or by querying a database. The first server (20) sends the scoring data packet (80) including the monthly net income data therein, and the risk server (22) compares the monthly net income data to a predetermined monthly net income data (an example of predetermined rule compliance data) stored in a memory module or database accessible by the risk server (22). The comparison may be made to determine whether a value, e.g., USD 5,000 recorded in the monthly net income data is greater than or equal to a value associated with the predetermined monthly net income data (e.g., USD 3,000). If the condition is met, then it moves on to another rule of the scoring process in which a similar process can be performed for other data contained in the scoring data packet (80).

The rules of the scoring process can generate compliance weighing data as outputs, which can be the same for each rule, or have different weights. At the end of the scoring process a rule compliance score data can be obtained which may be compared with a predetermined rule compliance score data, to obtain an approval data (760), a counteroffer data (770) or a denial data (780).

For example, the default rule compliance score data may have a score range of low, intermediate, or high (e.g., less than 199, between 200 and 499, and greater than 500 respectively). Then, the scoring process obtains the compliance score data associated with the processing of a scoring data packet (80), assigning a score, which is compared to the low, intermediate or high score ranges.

In an example of the invention, if the score obtained for the scoring data packet (80) falls in the low range, then the risk server (22) generates a denial data (780). Similarly, if the score obtained for the scoring data packet (80) falls in the intermediate range, then the risk server (22) generates a counteroffer data (770). And if the score obtained for the scoring data packet (80) falls in the high range, then the risk server (22) generates an approval data (780).

Transfer server (27): In this invention, transfer server (27) means a server or set of servers that belong to a system in which data is transferred through a computer network that interconnects servers and databases containing, managing and modifying profiles or accounts associated with users. For example, such a system where data is transferred through a computer network may be the computer system of a banking or financial institution, and the profiles or accounts correspond to savings, checking, credit, and similar accounts associated with a user profile, where the user is a person or an entity, such as a company or institution.

Accordingly, the transfer server (27) may be a server of a banking or financial institution. The transfer server (27) may have a memory module, or access to a database, wherein instructions are stored that when executed by the transfer server (27) generate a transfer of data from a database of the bank, or an account of a user to another database or account. The transfer server (27) may be configured to change an account data representing a cash in, cash out, or record of a value owed related to a credit product.

The transfer server (27) may connect to other servers running processes for creating and modifying credits associated with a user account or user profile of a user. Examples of such servers are AS/400 servers (hardware) configured to operate with an object-based OS/400 operating system and libraries, and upgrades thereto, such as iSeries® IBMi servers, PowerSystems, and the like of IBM.

Identification server (24): In this invention, identification server (24) will be understood as a server that connects to the first server (20) and has access to a memory module or database containing instructions that allow executing one or more stages of some modalities of the method disclosed herein, when executed by the identification server (24).

In particular, the identification Server (24) may be a server configured to manage a web service for generating and authenticating temporary One Time Passwords (OTP).

In several embodiments of the system and method in this invention, the identification server (24) connects to the first server (20) via a web service architecture through a communication protocol, such as REST, SOAP, HTTP, HTTP/S, among others.

In these embodiments, the first server (20) sends a request to the identification server (24) to obtain via the identification server (24) an identification data packet including an OTP key data. When the request is received, the identification server (24) may run a process, or trigger such a process on another computing device or server, to generate the OTP key data and then send to a user address that is selected from a phone number, e-mail address, social network profile address, and combinations thereof.

For example, the identification server (24) may communicate with an e-mail, telephony, or social network server to send the OTP key data.

Also, the identification server (24) may be programmed to receive through the first server (20) an OTP input data entered by the user into the computing device (10) after receiving the identification data packet, wherein the computing device (10) transmits the OTP input data to the first server (20) and then the first server (20) sends the data to the identification server (24).

In some embodiments of the method in this invention, the first server (20) may obtain an OTP validation data when the OTP input data matches the OTP key data. In this case, the identification server (24) sends the OTP key data to both the first server (20) and the user address.

In other embodiments of the method in this invention, the identification server (24) receives OTP input data through the first server (20), and then, the identification server (24) obtains the OTP validation data when the OTP input data matches the OTP key data.

Also, the identification server (24) may run a counting process that increments a counter by one unit, each time the stages of generating the OTP key data and comparing the OTP key data with the OTP input data, are executed. When the counter reaches a predetermined value, the process ends and an error message is displayed on the computing device (10).

Security server (25): In this invention, a security server (25) is understood to be a server connected to inputs of the first server (20) which receive data from the computing device (10), second server (30) and the risk server (22), and which has access to a memory module or database containing instructions which, when executed by the security server (25), allow one or more stages of some embodiments of the method disclosed herein to be executed.

In particular, the firewall (25) allows establishing a secure connection between the first server (20), the computing device (10), second server (30) and the risk server (22), and other servers or computing devices (10) that may connect to the first server (20).

The firewall (25) may run queries on databases containing a registry of computing devices (10) and servers authorized to send or receive data from the first server (20). The security server (25) may run processes or stages of comparing identification data or tags that identify computing devices (10) and servers authorized to send or receive data from the first server (20) and verifying whether the identification data or tags match the database record accessed by the security server (25).

Similarly, the firewall (25) may be programmed to perform any other security verification and secure connection establishment techniques between servers and computing devices known to a person reasonably skilled in the art.

An example of a firewall (25) is a server with a DataPower® system, which is a component that enables secure communication between the web services with which the first server (20) interacts. DataPower® is installed on a server that is configured to intercommunicate all the servers by means of a communication protocol or secure connection.

In addition, the firewall (25) may be replaced by any other system that allows a secure connection to be established, such as firewall systems, VPN systems, and equivalent systems known to a person reasonably skilled in the art.

Secure connection: In this invention, a secure connection is understood as a connection between a computing device (10) or a server or set of servers (20, 25, 30, 40, 22, 24) with other computing devices (10) or servers (20, 25, 30, 40, 22, 24). The secure connection is characterized in that a firewall (25) or equivalent security system validates data or identification tags of the computing devices (10) or servers (20, 25, 30, 40, 22, 24) that send and receive data using the secure connection. This prevents unauthorized access from computing devices (10) of servers that do not have valid identification data or tags.

Core banking: In this invention, core banking means a server or set of servers (20, 25, 30, 40, 22, 24) interconnected with each other, in order to perform one or more stages of any embodiment of the method disclosed herein.

Pre-validation process and security filters (400) or pre-validation process and filters (400): In this invention, pre-validation process and security filters (400) or pre-validation process and filters (400) means a method having stages executed by one or more servers, e.g., servers (20, 25, 30, 40, 22, 24). The pre-validation process and security filters (400) have stages that allow identifying whether computing devices (10) and servers are authorized to send or receive data from the first server (20), when executed. An example of a pre-validation and security filtering process (400) is that performed by a DataPower® system. In any embodiment of the method disclosed herein, the pre-validation process and security filters (400) may be executed by a firewall (25).

Web service: Web services allow servers (20, 30, 40, 22, 24, 27) and computing devices (10) to exchange data and communicate with each other, regardless of architectural differences in software or hardware. By means of web services a request for information can be received, the said request can be processed and the requested data returned, generally in the form of data (“XML”) or similar programming languages used in the transmission of information over computer networks, such as the Internet. The types of web services operate through communication protocols, e.g., SOAP (Simple Object Access Protocol) or its later versions, representative state transfer (“REST”), protocol

(“HTTP/HTML”) and XML language: remote procedure call (“XML-RPC”).

Communication Protocols: In this invention communication protocols will be understood as protocols that establish rules for identifying, packing, multiplexing or processing data configured to transmit such data between computing devices (10) and servers (20, 30, 40, 22, 24, 27).

TCP/IP, HTTP and HTTP/s are examples of some widely accepted protocols currently used in communication networks.

An example of a communication protocol is the Hypertext Transfer Protocol Secure (HTTP/S), which enables secure communication using encryption and third-party verification authorities or organizations.

Similarly, communication protocols applicable to web service architectures in which computing devices (10) and servers (20, 30, 40, 22, 24, 27) can be interconnected, are described below.

SOAP is a standard maintained by the World Wide Web Consortium (“W3C”). SOAP web services are defined using a Web Services Description Language (“WSDL”) file. This file contains the information necessary to generate a properly formatted request and describes the format of the response. Configuring web services to monitor a SOAP web service requires a properly configured WSDL file. SOAP requests are generally sent using a POST HTTP request method.

REST does not have a standard that is maintained by the W3C. Consequently, the definition of the format for requests and responses is designed and implemented by the user providing the web service. The use of REST is very popular due to its simplicity and ease of implementation. REST requests are generally sent using a GET HTTP request method where all parameters are passed in the URL. However, the response from the web service is typically XML, JavaScript Object Notation (“JSON”) or something similar. POST can also be used as a request format for REST.

HTTP/HTML/TEXT is used for those web services that return text or HTML strings instead of XML. This type of web service is similar to REST, the format for the request and response is defined. An example of this is request information from a page that will perform some processing and return a message indicating whether it was successful or not.

Hash Message Authentication Code (“HMAC”) and Message Digest Process 5 (“MD5”) are types of message authentication codes calculated using a cryptographic hash function in combination with a secret key. This is used in the context of web services to encrypt the request to ensure its integrity and distinguish one request from another. For example, parts of the web service request can be encrypted using HMAC or MD5 processes. Other encoding techniques can also be used, as experts in the field will understand.

However, the foregoing examples should not be viewed as limiting the systems and methods described in this disclosure to any particular type of protocol.

Transversal Sales Module (TSM): It will be understood in this invention by Transversal Sales Module (TSM) a software module, web application, mobile application (APP) or application programmable interface (API) that communicates one or more computing devices (10) with at least one server (20, 30, 40, 22, 24, 27). The Transversal Sales

Module (TSM) may be managed by a communication server (40) that connects between the first server (20) and the computing device (10) by establishing a communication protocol. The communication server (40) may be part of a web service architecture that integrates said communication server (40) with one or more computing devices (10) at least one server (20, 30, 40, 22, 24, 27).

In several embodiments of the method and system in this invention, the Transversal Vending Module (TSM) has a presentation layer configured to display messages and user screens on the computing device (10) and capture commands and data entered by the user on his/her computing device (10); and an application layer configured to establish a communication protocol with the first server (20). For example, the communication protocol may be selected from HTTPS, SOAP, or REST.

Presentation layer: It will be understood in this invention by presentation layer a front-end component configured to present on a display device having the computing device (10) messages related to data, commands and requests that are exchanged between the computing device (10) and one or more servers (20, 30, 40, 22, 24, 27). In addition, the presentation layer allows for capturing commands, tags or data that are produced by the computing device (10) when the user interacts with a Human Interface Device (HID).

The presentation layer generally corresponds to a software element installed on a server configured to manage the Transversal Sales Module (TSM), e.g., a communication server (40).

Application layer: In this invention, an application layer is understood as a back-end component configured to obtain, generate, send, receive and process data related to data communication, tags and commands between the computing device (10) and one or more servers (20, 30, 40, 22, 24, 27).

The application layer is the software component that runs the Transversal Sales Module (TSM) server to perform the processes related to translating data arriving from one or more servers (20, 30, 40, 22, 24, 27) into data that produces the display of messages, graphics, or information that can be understood, viewed, or heard by the user through the display device of the computing device (10), when entered into the presentation layer. In addition, the application layer may translate, package, filter, or process data received from the computing device (10) that represents information inputs entered by the user via the Human Interface Device (HID) of the computing device (10), and then send it to one or more servers (20, 30, 40, 22, 24, 27).

In several embodiments of the system and method in this invention the Transversal Sales Module (TSM) may be an application programming interface (API) integrated to the mobile application or application (APP) is a Progressive Web App. In this case the application layer may display messages, notifications, screens and other information elements on a screen generated by the mobile application.

Software Program or Mobile Application (APP): In this invention, a software program or mobile application (APP) shall be understood as a software component configured to be accessed by a computing device (10). For example, the mobile application (APP) may be a PWA, native APP, hybrid APP, web page, other equivalent types of applications known to a person reasonably skilled in the art, and combinations thereof.

Progressive web app (PWA): A PWA application is a web application that does not occupy memory space on the computing device (10) because its support is on a virtual server or cloud server, and can work for all users regardless of the browser they use because it can be adapted to each type of browser. In addition, a PWA application can include features of mobile applications such as push notifications, GPS and can also download a shortcut that is installed on a user interface of a computing device (10), e.g., a screen, home window or application menu, without the need to download it from an app store. Furthermore, the PWA applications can be updated automatically without adding load to the computing device (10).

In addition, the PWA application can work without an internet connection thanks to a feature called Service Worker, which allows you to perform actions within the application without a stable connection, because PWA applications can store information in cache memory, just as native applications do.

Also, PWA application is secure because it handles security protocols for handling information such as TLS (Transport Layer Security). Additionally, the PWA application can be shared by URL through text messages and it is very user friendly because its design and experience is like a native application. Also, PWA applications can include responsive design, which means that they can run on any mobile device with any screen resolution.

Credit or Financial Product: In some modalities of the method and system, credit or financial product means a service offered by an organization that provides financial services, which allows a user to store, request, use, collect, invest (deposit in exchange for a return) money, either physically (such as in a bank vault) or digitally. Examples of financial products are savings accounts, checking accounts, virtual wallets, credit cards, revolving credit, and combinations thereof.

In some embodiments of the method and system, a financial product is provided to the user/client when an organization offering financial services gives the user/client access to a financial product, where the user/client may be a natural or legal person.

In general, the financial product is granted after the user/client requests to open the financial product. Opening of the financial product is a process performed by a user, natural or legal person, e.g., the user/client, to request to an organization providing financial services the access to a financial product. In some embodiments of the disclosed method and system, after the user, e.g., the user/client, applies to open the financial product, the financial services organization evaluates acceptance criteria to identify whether the user meets conditions for access to a financial product. Examples of acceptance criteria are debt capacity, amount of income, assets owned by the user, credit history, and other equivalent indicators.

User history and profiling data: User history and profiling data may include credit scores, credit history, estimated income data of a user, income to debt capacity ratios, foreclosure histories, collection processes, cancellation of financial products, data related to payment of financial obligations, such as days past due, maximum number of days past due. For example, the second server (30) may belong to companies dedicated to providing financial information services, such as Experian-Datacredito, TransUnion, Equifax, and similar or equivalent companies, platforms or services known to a person reasonably skilled in the art.

In some embodiments of the system and method in this invention, the user history and profiling data may include medical records, medical history, academic transcripts and technical trainings, data taken from social networks, surveys, interviews, and in general, information that allows identifying patterns or habits of behavior, consumption and health of a user.

Transaction history data: In some embodiments of the disclosed method and system, user/client transaction history data means data containing information related to transactions that a user/client has exercised through any transactional channel that allows the user/client to deduct a value from an account, or increase credit owed on one or more financial products. For example, transaction history data may include information related to the number of purchases the user/client has made, maximum amount and minimum amount the user/client transfers through a transactional application, date of last user/client transaction, times of day and days of the week the user/client makes or receives transfers, and other equivalent types of information.

Databases: It will be understood in the present invention that a database is a set of data stored in a memory register systematically for later use.

Databases can be selected from hierarchical databases, network databases, transactional databases, relational databases, multidimensional databases, object-oriented databases, document databases, deductive databases, and other databases known to a person reasonably skilled in the art.

Artificial intelligence processes: Some of the artificial intelligence processes executed by the first server (20) or the risk server (24) may be based on artificial intelligence or machine learning techniques, such as linear classification processes (e.g. logistic regression, Naive Bayes classification, Fisher linear discriminant), support vector machines, least squares support vector machines, quadratic classification processes, kernel estimation, k-th neighborhood, decision trees, random forests, neural networks (e.g., supervised, back propagation, forward propagation), learning vector quantization, and other machine learning techniques known to a person reasonably skilled in the art.

Rule-based artificial intelligence processes: Some of the artificial intelligence processes executed by the first server (20) or the risk server (24), may be decision trees, random forests, gradient boosted trees (gradient boosted trees) and other rule-based machine learning techniques known to a person reasonably skilled in the art.

Computer network: A computer network is understood as a set of technical means that allow remote communication between autonomous equipment, such as computer devices and servers. It usually involves transmitting data by electromagnetic waves through several media (air, vacuum, copper cable, fiber optics, etc.). Non-limiting examples of a communication network are the Internet, WAN, and LAN. It will be understood that the method and system disclosed herein may employ any type of equivalent communication network known to a person reasonably skilled in the art.

User identification data: In some embodiments of the system and method in this invention, the user identification data includes the user's name, personal identification number (e.g., citizenship card, ID), social security number, current residence address, or any other distinguishing data to ensure that the user identification data is associated with the user.

Request data: In this invention, request data means data generated in a computing device (10) connected to the first server (20) when a user enters a selection command associated with a type of credit. The request data may include a tag identifying the computing device (10), a tag identifying a user profile with which the user logs into the computing device (10), e.g., when logging into a software program or mobile application (APP). Moreover, the request data includes information related to the user's selection of an item displayed on the display device of the computing device (10), and chosen by the user through the user's interaction with the Human Interface Device (HID) of the computing device (10).

In some embodiments of the system and method in this invention, the request data is generated when the user enters a selection command via the Human Interface Device (HID) of the computing device (10), which is associated with the user's choice of a financial product or credit they wish to access. Similarly, the selection command may be associated with the user's selection to initiate a process that is presented as a message on the display device of the computing device (10), e.g., for a process of transferring data between a first database, node of a data network, or account to one or more other databases, nodes of a data network, or accounts.

Selection command: In this invention, selection command will be understood as a data generated by the computing device (10) when the user interacts with the Human Interface

Device (HID) of the computing device (10) to select an option, item or message that is displayed on the display device of the computing device (10).

Type of credit: In this invention, type of credit will be understood as a type of credit that differentiates a credit from other credits. The type of credit can be classified and selected among vehicle credit, mortgage, educational credit, free investment credit, credit card, revolving credit, among other types of credit known to a person reasonably skilled in the art. The differentiation or classification of the types of credit can be based on the amount of credit, data of the ideal user who applies for credit (age, employment contract, scoring in credit bureaus, income amount, income/debt ratio, among others).

Scoring data packet (80): In this invention, scoring data packet (80) shall be understood as a data packet that includes a user history and profiling data, which serves as input to the risk server (22).

In some embodiments of the system and method in this invention, the scoring data packet (80) may include data or data packets obtained from databases to which the first server (20) does not have access. For example, the scoring data packet (80) may include data taken from bureau-type servers of companies engaged in providing financial information services, such as Experian-Datacredito, TransUnion, Equifax, and similar or equivalent companies, platforms or services known to a person reasonably skilled in the art.

Moreover, the scoring data packet (80) may include data taken from servers accessed by the first server (20). For example, the first server (20) may be configured to access a banking server or AS/400 servers (hardware) configured to operate with an object-based OS/400 operating system and libraries, and upgrades thereto, such as iSeries® IBMi servers, PowerSystems, and the like from IBM. Data exchange between the first server (20) and the AS/400 servers can be done by means of RPG (Report Program Generator) instructions).

Approval data (760): In this invention, approval data (760) means a data or data packet having information related to an approvable result of a risk engine or scoring process that is executed in response to a credit application of a user. For example, the approval data (760) may be generated at the risk server (20) when the risk engine or process of scoring processes a scoring data packet (80) and checks a plurality of compliance rules related to the credit, obtaining a rule compliance score data that is greater than a predetermined rule compliance score data related to the credit requested by the user.

Counteroffer data (770): Counteroffer data (770) means in this invention a data or data packet having information related to a counteroffer result of a risk engine or scoring process that is executed in response to a credit application of a user. For example, counteroffer data (770) may be generated at the risk server (20) when the risk engine or process of scoring processes a scoring data packet (80) and checks a plurality of compliance rules related to the credit, obtaining a rule compliance score data that is less than a predetermined rule compliance score data with the credit requested by the user, but greater than a predetermined rule compliance score data related to a different credit than the credit requested by the user.

In this way, the user can receive an offer of a different credit, thus saving processing and interaction time between the user and the system in this invention, as compared to the case in which the user must try multiple credit applications with different characteristics, such as term, amount, interest rate or type of credit (vehicle, mortgage, free investment, credit card, revolving credit, among others).

Denial data (780): Denial data (780) shall be understood in this invention to mean a data or data packet having information related to a denial result of a risk engine or scoring process that is executed in response to a user's credit application.

For Example, may be generated at the risk server (20) when the risk server or process of scoring processes a scoring data packet (80) and checks one or more of compliance rules related to the credit, obtaining a rule compliance score data that is less than a predetermined rule compliance score data related to the credit requested by the user and less than a predetermined rule compliance score data related to one or more other credits than the one requested by the user.

Any of the data selected from the approval data (760), counteroffer data (770), and denial data (780) may be a package or array of data that also includes identification data or tags that identify the client applying for credit (name, identification number, identification card, social security number, driver's license, residence address, bank account user profile data, and combinations thereof), identify a computing device (10) of the user (IP address, IMEI, cell phone serial, chip serial, among others), and data related to the date, time, IP address, and type of credit requested by the user.

Scoring process: In this invention, scoring process means a method comprising a sequence of stages in which a scoring data packet (80) is taken and takes at least one piece of data from said scoring data packet (80) and compares it with one or more compliance rules in order to obtain approval data (760), counteroffer data (770) or denial data (780).

Compliance rules: In this invention, a compliance rule means a stage of a risk scoring or risk engine method or process in which a scoring data packet (80) is taken as input and takes at least one piece of data from said scoring data packet (80) and compares it with one or more predetermined rule compliance score data, e.g., by means of a conditional (e.g., “if”, “where” loop) to obtain one or more rule compliance score data.

This comparison can be between numerical, alphanumeric, demographic and other types of data known to a person reasonably skilled in the art, that can be used in actuarial or risk analysis.

In any embodiment of the system and method disclosed herein, the compliance rules may be business rules of credit or insurance product scoring known to a person reasonably skilled in the art.

Demographic data: In this invention, demographic data shall be understood as data having information corresponding and inherent to characteristics of communities and human beings.

This general information on groups of people usually includes attributes such as age, gender, city, socioeconomic stratum, place of residence, as well as social characteristics such as occupation, family status or income. In analytical processes, demographic data are used to provide a deeper insight into a population, study its behavior and find patterns.

Classification processes: In this invention, classification processes are methods comprising a sequence of stages for grouping, separating, and sorting data according to one or more classification or grouping criteria. The classification process or method may predict a target class by analyzing a training data set.

Examples of classification processes are linear classification algorithms (e.g. logistic regression, Naive Bayes classification, Fisher's linear discriminant), support vector machines, least squares support vector machines, quadratic classification algorithms, kernel estimation, k-th neighborhood, decision trees, alternating decision trees, ID3 algorithms, C4 algorithms, C3 algorithms, C4.5 algorithms, Chi-square automatic interaction detection (CHAID) algorithms, decision stump trees, Fast-and-frugal trees, simple decision trees, linear decision trees, deterministic decision trees, randomized decision trees, non-deterministic decision trees, quantum decision trees, decision tree pruning, random forests, neural networks (e.g. supervised, backpropagation, forward propagation), learning vector quantization, and other machine learning techniques, algorithms or sorting processes known to a person reasonably skilled in the art.

Credit creation and disbursement process: In this invention, a credit creation and disbursement process, means a method, routine or process comprising stages that are executed on one or more servers, e.g., servers (20, 30, 40, 22, 24, 27). The credit creation and disbursement process, takes as inputs at least one of approval data (760) or counteroffer data (770), and a user acceptance data or counteroffer acceptance data that are generated from user interaction with the computing device (10) in response to an approval message (820) or counteroffer message (830) that is displayed on said computing device (10) notifying the user that the requested credit was accepted, or a different credit is offered.

The credit creation and disbursement process, transforms the inputs and outputs a credit creation and disbursement initiation request data that serves as input for document creation and database record modification processes, and data transfer processes to a user account (90).

In addition, the credit creation and disbursement process may have stages related to the creation or modification of accounts, records, or profiles in databases, e.g., databases in which a user's credit products, insurance, or bank accounts are recorded.

The credit creation and disbursement process may be, e.g., executed by means of web services that are requested by the first server (20) from servers configured to generate electronic documents, electronic promissory notes, virtual contracts, smart contracts, and equivalent documents known to a person reasonably skilled in the art.

Acceptance data: In this invention, application data means data generated in a computing device (10) connected to the first server (20) when a user enters a selection command associated with the acceptance of a credit. The user enters the selection command in response to a message displayed on his computing device (10) notifying him/her that the credit has been approved, which occurs when approval data (760) is obtained from the risk engine or scoring process.

Counteroffer acceptance data: In this invention, counteroffer acceptance data means data generated in a computing device (10) connected to the first server (20) when a user enters a selection command associated with the acceptance of a credit counteroffer. The user enters the selection command in response to a message displayed on his/her computing device (10) notifying him/her that the credit to which the user applied for was denied, but may access a different credit, which occurs when counteroffer data (770) is obtained from the risk engine or scoring process.

User account (90): In this invention, user account (90) means a data array registered in a database. The data array represents a bank account, virtual wallet, or banking network node where a user can receive or issue data representing money or tangible goods or intangible goods.

Selection detection process: In this invention, a selection detection process means a method or process comprising stages executed by one or more servers, e.g., the servers (20, 30, 40, 22, 24, 27). The selection detection process may have a stage of an “if” loop, “for” loop or a “where” loop in which user acceptance data or counteroffer acceptance data is obtained when a server (20, 30, 40, 22, 24, 27), e.g., server (20), receives an acceptance command, or counteroffer acceptance command that the user enters into the computing device (10) in response to an approval message (820) or counteroffer message (830) respectively.

Acceptance command and counteroffer acceptance command: Acceptance command and counteroffer acceptance command shall be understood in this invention as data or data packets generated by the computing device (10) when the user enters an input through the Human Interface Device (HID) of the computing device (10) in response to an approval message (820) (in the case of the acceptance Command) or counteroffer message (830) (in the case of the counteroffer acceptance command).

Approval message (820) and counteroffer message (830): In this invention approval message (820) and counteroffer message (830) will be understood as a message, display screen, audio output, or string of characters that is displayed on the display device of the computing device (10) for the purpose of notifying the user that the credit requested was approved (in the case of approval message (820) or that the credit requested was denied, but he/she is offered a different credit (in case of counteroffer message (830)).

Account identification data: In this invention, account identification data means data containing information related to an account, virtual wallet or banking network node to which the user has access. For example, it may include numeric or alphanumeric characters.

Registered identification data: In this invention, account identification data means data located in a database associated with a banking network or transaction network that identifies an account, virtual wallet or banking network node to which the user has access. For example, Account Identifier Data may include numeric or alphanumeric characters.

Validation data: In this invention, account identification data means data generated by a server, e.g., a server (20, 30), when said server executes a step, e.g., an “if”, “for”, or “where” loop, in which it obtains as output the validation data when the account identification data matches the registered identification data.

Transfer authorization data: In this invention, transfer authorization data means data generated by a server, e.g., a server (20, 30), when the server receives a validation data and an account identification data. The transfer authorization data is sent to a transfer server (27) configured to transfer money to the user's account (90) upon receipt of the transfer authorization data.

Issued credit data (1220): It will be understood in this invention by issued credit data (1220) a data that is received or generated by a server, e.g., a server (20, 30) when a credit creation process is completed. For example, when a server managing a database containing credit records generates a new record related to the creation of an approved credit for the user, it sends the issued credit data (1220) as a notification to the server (20, 30).

Disbursement confirmation data (1230): Disbursement confirmation data (1230) is understood in this invention to mean data that is received or generated by a server, e.g., a server (20, 30) when a transfer server (27) detects that transaction data equivalent to money is received in an account (90) of the user to whom a credit is granted.

User identity data: In this invention, user identity data shall be understood as a data or data packet containing information related to the identity of a user, e.g., ID number, alias or nickname, profile name, acronym of their name, corporate name of a legal entity, residence address, biometric data having information such as photographs, fingerprint records, voice records, records of time of entry of a pattern or password of a user, or any other data known to a person reasonably skilled in the art, that allows a user to be identified.

Registered identity data: In this invention, registered identity data shall be understood as a data or data packet that is stored in a database accessed by one or more servers, e.g., servers (20, 30, 40, 22, 24, 27), and that contains information related to the identity of a user, e.g., ID number, alias or nickname, profile name, acronyms of his/her name, company name of a legal entity, address of residence, biometric data that have information such as photographs, fingerprint records, voice records, records of time of entry of a pattern or password of a user, or any other data known by a person reasonably skilled in the art that allows to identify a user.

User profile data packet: In this invention, user profile data packet or data packet or data array shall be understood as the data stored in a database accessed by one or more servers, e.g., servers (20, 30, 40, 22, 24, 27), and which contains data with information related to a user profile, e.g., transactional history, history of non-payment of financial obligations, reports of the user in government and security databases (blacklists, Clinton list,

INTERPOL red notices, arrest warrants issued by a state, fraud reports associated with the user), demographic data related to the user or persons close to the user due to family, work or relational ties, identification number of credit products, bank accounts or insurances assigned or related to the user, and other data that allow to elaborate a user profile that are known to a person reasonably skilled in the art.

User identification process: In this invention, user identification process means a method having stages executed by one or more servers, e.g., servers (20, 30, 40, 22, 24, 27). The user identification process has a user input entered by the user as input in the computing device (10) and obtains as output a user authentication data.

The user identification process includes a comparison process having stages executed by one or more servers, e.g., servers (20, 30, 40, 22, 24, 27). The comparison process may have a stage of an “if”, “for” or “where” loop, wherein it takes as input the user identity data and a registered identity data and obtains a user authentication data when the user identity data and a registered identity data match.

User authentication data: In this invention, user authentication data means data obtained by a server, e.g., a server (20, 30) as an output of a user identification process.

User characteristics or valid characteristics: In this invention, user characteristics or valid characteristics means data containing information of a user related to compliance or non-compliance with rules of a verification process. The user characteristics or valid characteristics may be data selected from the user profile data packet. For example, one or more security databases may be queried through the first server (20) to determine from the user profile data packet whether there is non-compliance data of rules associated with the user.

For example, the rule may be that if in a security database or government and security database (blacklists, Clinton list, INTERPOL red notices, arrest warrants issued by a state, fraud reports associated with the user) a report associated with the user profile data packet is found, then, the method in this invention ends and an error message is displayed on the user's computing device (10).

In one example, the verification process may have a stage where it compares the user's age, which is found in the user profile data packet, and from a for, if or where loop determines that the age is outside a predetermined age range. For example, if for a certain type of credit, the applicant is required to be between 25 and 55 years old, then, if in the verification process it is identified that in the user profile data packet there is a user age data indicating that the user is 18 years old or 76 years old, then the method in this invention ends and an error message is displayed on the user's computing device (10).

Similar stages can be applied when comparing any data in the user profile data packet, against a rule in the verification process.

Classification lists: In this invention, classification lists shall be understood as data, arrays, files, or data vectors containing information related to profiles, listings, groupings, associations or communities that relate to persons or companies.

Some examples of classification lists are blacklists, Clinton List, INTERPOL Red Notices, state-issued warrants, fraud reports associated with the user, and other types of legal, financial, social, or government information related to a user. The classification lists can be searched against a security database or government and security database.

Verification process: In this invention, a verification process means a method having stages executed by one or more servers, e.g., servers (20, 30, 40, 22, 24, 27). The verification process has stages wherein an input data, e.g., a data from the user profile data packet is compared against a data obtained from at least one database, e.g., a security database, or governance and security database, to determine from the input data (such as the data that may be taken from the user profile data packet) whether a rule violation data exists.

The rules correspond to stages of the verification process where an input is taken as input data, e.g., in case the input data is from the user profile data packet, the input data could include the name, personal identification number, bank account number, identification number of a company in which the user is listed as a legal representative, and one or more data received from the security database, or governance and security database.

From said inputs, if in the rule stage the data in the user profile data packet is found to match a data associated with a report or ranking list, then a reject data is generated as an output of the verification process, which ends the method in this invention, when processed by a server, such as the first server (20).

Also, the verification process may have stages based on processes, methods or algorithms based on artificial intelligence, machine learning or deep-learning that take the input data and process it with rules, routines, stages or steps that allow to classify the input data as a valid input data or an invalid input data.

Optionally, when the verification process determines that the input data is invalid data, an instruction, data or command may be sent from the first server (20) to the computing device (10) or to a server administering an APP or web page accessed by the computing device (10), wherein the instruction, data or command causes the computing device (10) or server to display a rejection message on the display device of the computing device (10) notifying the user that the credit application was rejected.

Selection process: In this invention, a selection process means a method having stages performed by one or more servers, e.g., servers (20, 30, 40, 22, 24, 27) and by a computing device (10). The selection process has stages in which data is obtained from user inputs entered by the user into a computing device (10) from which data is generated containing information related to the user's choice or acceptance of credit terms, such as term, amount, interest rate, type of credit, among others. Also, the selection process has stages in which the data obtained by the computing device (10) are taken and processed in one or more servers to obtain data that when transmitted to the computing device (10) generate the display of messages to the user, so that the user responds with a user input in which he/she chooses or rejects something related to the message.

For example, the first server (20) may send a credit value and installment selection message data to a computing device (10) to display a credit value and installment selection message (510) on the display device of the computing device (10). The user upon receiving the credit value and installment selection message (510) interacts with the

Human Interface Device (HID) of the computing device (10) by entering an input in which he/she chooses at least the amount and installment of the credit, which upon being processed by the computing unit of the computing device (10) generates a value and installment selection data, and sends it to the first server (20).

Based on the amount and installment value contained in the value and installment selection data, the first server (20), or another server connected to the first server (20), takes said value and installment selection data as input to a mathematical model, wherein said mathematical model obtains as output at least one credit terms data, e.g., the credit terms data may have information of an interest rate, total interest, insured value, total value or amount to be paid, among others. The credit terms data is sent by the first server (20), or any other server, to the computing device (10). The computing device (10) displays on its display device a message of credit value and installment results generated by the first server (20) considering the credit terms data. Upon receiving the credit value and installment results message, the user interacts with the Human Interface Device (HID) of the computing device (10) by entering an input or command accepting or rejecting the conditions, which upon being processed by the computing unit of the computing device (10) generates an acceptance data or a denial data that is sent to the first server (20).

Mathematical model: It will be understood in this invention by mathematical model a method having stages executed by one or more servers, e.g., servers (20, 30, 40, 22, 24, 27). The mathematical model has stages in which numerical or alphanumeric data are processed with techniques, routines or sequences of stages related to mathematical, statistical, probabilistic operations and combinations thereof.

An example of a mathematical model is a model that receives as input a value and installment selection data, containing numerical data of a value corresponding to the amount of credit and a value corresponding to the number of months of credit. In this example, the mathematical model may have additional inputs determined by one or more servers, or by one or more rules or stages of the method in this invention, e.g., a rate data, interest rate, maximum term, maximum amount, minimum amount, among others. The mathematical model of the example may calculate a lump sum interest value, amortization values, value of an insurance associated with the credit, monthly installment value, among others. One or more of these values can be recorded in at least one credit terms data.

Credit terms data: The credit terms data can have information on an interest rate, total interest, insured value, value or total amount to be paid, monthly payment, amortization tables, among others.

Value and installment acceptance command and value and installment rejection command: In this invention, value and installment acceptance command and value and installment rejection command shall be understood as data entries entered by the user into the computing device (10) in response to the credit value and installment results message displayed on the display device of the computing device (10). The value and installment acceptance command and the value and installment rejection command may be words, character sequences, voice commands, gestures, or any other means of communication or selection wherein the user enters a command via the Human Interface Device (HID) of the computing device (10).

Rate data: In this invention, rate data will be understood as a data that includes information related to inputs for a mathematical model that calculates a credit terms data. The rate data may include numeric or alphanumeric values that are obtained from a database from the user profile data packet. For example, the rate data can have a value for interest rate, minimum amount, maximum amount, and so on.

Request: In this invention, a request is understood to be data sent from a computing device (10) or a server (20, 22, 25, 30, 27, 40) to another server (20, 22, 25, 30, 27, 40). In the data sent is information related to a process, method, routine or algorithm to be executed by the server (20, 22, 25, 30, 27, 40) receiving the request. The request may include information related to inputs of the process, method, routine, or algorithm to be executed by the server (20, 22, 25, 30, 27, 40) receiving the request. Moreover, the request may include an identification data of the computing device (10) or a server (20, 22, 25, 30, 27, 40) sending the request, or a user identification data of a user interacting with the computing device (10) during execution of any method in this invention.

The server (20, 22, 25, 30, 27, 40) receiving the request may run said process, method, routine or algorithm, and generate a response data which is sent to the computing device (10) or server (20, 22, 25, 30, 27, 40) that sent the request.

This invention shall be understood as not being limited to the embodiments described and illustrated, for as will be evident to a person skilled in the art, there are possible variations and modifications which do not depart from the invention spirit, which alone is defined by the following claims.

1. A method of approving and disbursing a loan (2000) comprising the stages of:
i) receiving at a first server (20) a request data (1) generated in a computing device (10) connected to the first server (20) when a user enters a selection command associated with a type of credit;
ii) obtaining on the computing device (10) a user identification data (600) provided by the user on said computing device (10); and
ii-a) transmitting the user identification data (600) to the first server (20);
iii) obtaining by a second server (30) connected to the first server (20) a scoring data packet (80) comprising a user history and profiling data, wherein the second server (30) is configured to extract from a database the user history and profiling data from the user data of stage ii);
iv) iv) obtaining by a risk server (22) connected to the first server (20) an approval data (760), a counteroffer data (770) or a denial data (780) by a scoring process taking as input the scoring data packet (80) and a credit-related compliance rule, wherein the scoring process is selected from classification processes and rule-based artificial intelligence processes; and
v) v) executing via the first server (20) a credit creation and disbursement process, if the approval data (760) or the counteroffer data (770) is obtained, where the credit creation and disbursement process includes the sub-stages:
V1) obtaining user acceptance data or counteroffer acceptance data from user interaction with the computing device (10) and communication between the computing device (10) and the first server (20), and
V2) creating a credit and transfer a data representing money in an account (90) of the user (1200).

2. The method of claim 1, wherein in sub-stage V2) of step v) the user acceptance data and the counteroffer acceptance data are obtained through the first server (20) by a selection detection process that takes as input an acceptance command, or counteroffer acceptance command that the user enters into said computing device (10) in response to an approval message (820) or counteroffer message (830) respectively, wherein the first server (20) sends to the computing device (10) the approval message (820) or counteroffer message (830) after stage iv).

3. The method of claim 2, wherein the selection detection process includes:
S1) displaying on the computing device (10) the approval message (820) or the counteroffer message (830) if the approval data (760) or the counteroffer data (770) are obtained in stage iv) respectively;
S2) detecting in the computing device (10) that the user enters through said computing device (10) the acceptance command, or counteroffer acceptance command in response to the approval message (820) or counteroffer message (830) respectively;
S3) receiving at the first server (20), from the computing device (10), the acceptance command, or counteroffer acceptance command; and
S4) generating via the first server (20) the user acceptance data or the counteroffer acceptance data.

4. The method according to any of the preceding claims, wherein stage v) further comprises the sub-stages of:
V1.1) sending via the first server (20) to the computing device (10) a fillable data packet (91);
V1.2) displaying on the computing device (10) a form (93) contained in the fillable data packet (91);
V1.3) obtaining by means of the computing device (10) a completed data packet (92) when the user fills in the form (93) in the computing device (10) and enters into the computing device (10) an account identification data associated with the user's account (90) wherein the data representing money is transferred;
V1.4) obtaining through the first server (20) a validation data when the account identification data matches a registered account identification data stored in a database accessed by said first server (20) and proceed to sub-stage V1.5), otherwise ending stage v) and displaying on the computing device (10) an error message;
V1.5) obtaining via the first server (20) a transfer authorization data from the validation data and the account identification data, wherein the transfer authorization data is sent to a transfer server (27) configured to transfer the data representing money to the account (90) of the user when it receives the transfer authorization data.

5. The method according to claim 4, wherein stage V2) further comprises before stage V1.5) a stage f) of executing via the first server (20) a user identity verification process comprising the sub-stages of:
F1) sending from the first server (20) a request to an identification server (24);
F2) obtaining via the identification server (24) an identification data including an OTP key data when the request is received;
F3) sending the identification data to a user address that is selected from a telephone number, e-mail address, social network profile address, and combinations thereof;
F4) obtaining in the computing device (10) an OTP input data that the user enters into the computing device (10) after receiving the identification data;
F5) sending from the computing device (10) to the first server (20) the OTP input data; and
F6) obtaining an OTP validation data when the OTP input data matches the OTP key data and go to stage V1.5), otherwise repeat sub-stages F2) to F5).

6. The method of claim 5, wherein sub-stage F6) further comprises a counting process executed by the identification server (24) that increments a counter by one unit each time sub-stages F2) to F5) are executed, wherein upon the counter reaching a predetermined value, sub-stage F6) ends and an error message is displayed on the computing device (10).

7. The method according to any of claims 4 to 6, further comprising:
V1.6) obtaining via the first server (20) an issued credit data (1220) and a disbursement confirmation data (1230), where the disbursement confirmation data (1230) is generated in the transfer server (27) when it detects that the user receives in his/her account (90) the data representing money, and where the issued credit data (1220) is generated on the first server (20) when the transfer authorization data is obtained.

8. The method according to any of the preceding claims, further comprising a stage a) prior to stage i) of obtaining a user authentication data from a user identification process comprising the sub-stages of:
A1) obtaining a user identity data from a user input entered by the user into the computing device (10);
A2) obtaining through the first server (20) a user authentication data by a comparison process that takes as input the user identity data and a registered identity data associated with a user profile data packet, and verifying whether the user identity data matches the registered identity data, wherein the registered identity data and the user profile data packet are stored in a database configured to be queried by the first server (20); and
A3) proceeding to stage i) if the identity data matches the recorded identity data, otherwise displaying an error message on the computing device (10) and repeating sub-stages A1) to A3).

9. The method according to claim 8, further comprising a sub-stage B) prior to stage ii) of executing on a firewall (25) connected to inputs of the first server (20) receiving data from the computing device (10), the second server (30) and the risk server (22), a pre-validation process and security filters (400) configured to establish a secure connection between the first server (20) second server (30), the risk server (22) and the computing device (10).

10. The method according to claim 8, wherein between stages a) and ii) a stage of verifying a user characteristics and ranking lists (430) is executed via the first server (20) by a verification process comprising the sub-stages of:
querying through the first server (20) a security database to determine from the user profile data packet whether there is a rule violation data associated with the user;
if the database contains the rule violation data, then the first server (20) executes an end the method step, otherwise it ends the verification process and proceeds to stage iii).

11. The method of claim 9, further comprising before stage iii) a sub-stage B) of executing through the first server (20) a selection process configured to obtain at least one credit terms data comprising the sub-stages of:
B1) displaying on the computing device (10) a credit value and installment selection message (510);
B2) receiving at the first server (20) a value and installment selection data generated by the computing device (10) when the user enters by means of said computing device (10) a value and installment selection command in response to the value and installment selection message; and
B3) executing through the first server (20) a process which has as input the value and installment selection data and obtaining as output the at least one credit terms data;
B4) displaying on the computing device (10) a message of credit value and installment results generated by the first server (20) considering the credit terms data;
B5) receiving at the first server (20) an acceptance data generated by the computing device (10) if the user selects by said computing device (10) a value and credit installment acceptance command, in response to the value and credit installment results message and proceed to stage iii), and
B6) receiving at the first server (20) a denial data if the user selects by means of said computing device (10) a value and installment rejection command, in response to the credit value and installment result message and proceed to sub-stage B1).

12. The method of claim 11, wherein prior to substage B3) the first server 20) executes a stage of obtaining a rate data in a database from the user profile data packet, and wherein the mathematical model takes as input the rate data to calculate the at least one credit terms data, in substage B3).

13. A credit approval and disbursement system (2000) comprising:
a first server (20) having a processing module configured to:
establish connection with a computing device (10);
receive a request data (1) generated in the computing device (10) when a user enters a selection command associated with a type of credit;
receive from the computing device (10) a user identification data (600) provided by the user on said computing device (10);
run a credit creation and disbursement process from an approval data (760) or counteroffer data (770), where the credit creation and disbursement process include:
obtaining a user acceptance data or counteroffer acceptance data from user interaction with the computing device (10) and communication between the computing device (10) and the first server (20);
creating credit and transfer a data representing money in an account (90) of the user (1200);
a second server (30) connected to the first server (20) and having a processing module configured to obtain a scoring data packet (80) comprising a user history and profiling data, wherein the second server (30) is configured to extract from a database the user history and profiling data from the user data of the previous stage; and
a risk server (22) connected to the first server (20), and having a processing module configured to obtain approval data (760), counteroffer data (770), or denial data (780) by executing a scoring process that takes as input the scoring data packet (80) and a credit-related compliance rule, wherein the scoring process is selected between ranking processes and rule-based artificial intelligence processes,
wherein the first server (20) is connected to the second server (30), the risk server (22) and the computing device (10) via a computing network wherein the request data (1), user identification data (600), approval data (760), counteroffer data (770), user acceptance data, counteroffer acceptance data, scoring data packet (80), history data and user profiling are exchanged.

14. The system of claim 13, further comprising a Transversal Sales Module (TSM) configured to establish the connection between the first server (20) and the computing device (10), wherein the Transversal Sales Module (TSM) has:
a presentation layer configured to display messages and user screens on the computing device (10) and capture commands and data entered by the user into their computing device (10); and
an application layer configured to establish a communication protocol with the first server (20) selected from HTTPS, SOAP, or REST.

15. The system of claim 13, wherein the Transversal Sales Module (TSM) is managed by a communication server (40) that connects between the first server (20) and the computing device (10) by establishing a communication protocol.

16. The system according to any of claims 13 to 15, wherein the first server (20) is configured as a broker-like server, wherein the connections from the first server (20), the second server (30), the risk server (22), establish a communication protocol selected from HTTPS, SOAP, or REST.

17. A computer program comprising instructions, which when the program is executed on a system with:
at least one first server (20); a second server (30), a risk server (22), wherein the first server (20) is connected to the second server (30), the risk server (22) and the computing device (10) via a computer network in which data including a request data (1) is exchanged, a user identification data (600), an approval data (760), a counteroffer data (770), a user acceptance data, a counteroffer acceptance data, scoring data packet (80), history data and user profiling; causes the system to perform the stages of a method according to any of claims 1 to 13.

18. A computer-readable medium comprising instructions, which when executed on a system with:
at least one first server (20); a second server (30), a risk server (22), wherein the first server (20) is connected to the second server (30), the risk server (22) and the computing device (10) via a computer network in which data including a request data (1) is exchanged, a user identification data (600), an approval data (760), a counteroffer data (770), a user acceptance data, a counteroffer acceptance data, scoring data packet (80), history data and user profiling; causes the system to perform the stages of a method according to any of claims 1 to 13.
